(19) United States
(12) Patent Application Publication
(10) Pub. No.: US 2025/0162490 A1
(43) Pub. Date: May 22, 2025

(54) STRUCTURE FOR A SUBSTRUCTURE

(71) Applicant: European Trailer Systems GmbH, Moers (DE)

(72) Inventors: Markus LEUKERS, Moers (DE); Roger REMMEL, Moers (DE)

(21) Appl. No.: 18/841,875

(22) PCT Filed: Mar. 1, 2023
(86) PCT No.: PCT/DE2023/100164

§ 371 Date: Aug. 27, 2024

(30) Foreign Application Priority Data
Mar. 3, 2022 (DE) 10 2022 105 102.1

(51) Int. Cl. B60P 7/08; B60J 7/04; B60J 7/057; B61D 39/00; B62D 33/02; B65D 88/12

(52) U.S. Cl. CPC B60P 7/0876; B60J 7/042; B60J 7/0576; B60P 7/0815; B61D 39/001; B61D 39/006; B62D 33/0207; B65D 88/125

(57) ABSTRACT

A structure for a substructure includes a body, and an openable roof. The roof is displaceable at its edges along two longitudinal beams of the body. In a closed state, the roof closes a roof opening between the two longitudinal beams. In an opened state, the roof predominantly exposes the roof opening between the two longitudinal beams. Each longitudinal beam is supported in a height-adjustable manner relative to the substructure via at least one lifting assembly. The body is adjustable at least in height relative to the substructure depending on a height adjustment of the lifting assembly. At least one lifting drive is provided which displaces the body together with the roof in height relative to the substructure. The lifting drive applies a force in the substructure for compressing a load protruding beyond the substructure by lowering the body with the closed roof onto the substructure against the protruding load.

### STRUCTURE FOR A SUBSTRUCTURE

The present disclosure relates to a structure for a substructure, such as a truck, trailer, semitrailer, railway wagon, dump truck, or container, comprising a body and an openable roof, wherein the roof is displaceable at its edges along two longitudinal beams of the body, wherein the roof closes a roof opening between the two longitudinal beams in a closed state, wherein the roof largely exposing the roof opening between the two longitudinal beams in an open state, wherein each longitudinal beam is supported in a height-adjustable manner relative to the substructure via at least one lifting assembly, wherein the body is adjustable at least in height relative to the substructure depending on a height adjustment of the lifting assembly, wherein at least one lifting drive is provided which displaces the body together with the roof in height relative to the substructure. The present disclosure further relates to a method for compressing a load which can be placed in a loading space of a substructure, such as a truck, trailer, semitrailer, railway wagon, dump truck or container, as well as a method for compressing a compressible load which protrudes beyond an upper opening of a substructure, wherein the substructure has a structure with an openable roof.

### BACKGROUND

The transport of free-flowing and so-called floating bulk goods, such as grain, hay, grass and corn silage, in substructures that can be loaded from above, such as harvest trailers, requires a cover in road traffic, as this is a lightweight load that can be blown away by wind or air flow, for example, and can fall out of the loading space of a trailer, for example. Furthermore, it is desirable to fully utilize a loading space even for loads with a relatively low density of up to around 600 kg/m³ so that transport is economical. Therefore, there are regulations that require the top opening of substructures, such as debris containers, to be covered even when the vehicle is running empty to prevent dust from escaping.

Furthermore, it is desirable for the load to arrive at its destination completely dry to prevent spoilage, for example due to the formation of mold. To achieve this, the load must be covered as required and, on the other hand, covered tightly enough to protect the load from rain or weather. In addition, the vehicle to be moved, in which the load is carried, must not exceed a maximum overall height, so that transport is possible, for example, under bridges or through a tunnel.

In order to make better use of the loading space, in practice the load is piled up above the upper opening, so that a cover does not completely enclose the load. When driving on uneven ground, the load is shaken and gradually collapses. The disadvantage here is that unnecessary distances have to be traveled before a permissible level for driving on public roads is reached. There is also a risk that the load will either protrude further over the upper opening and be dispersed in the wind, or that the loading space will not be optimally utilized.

An agricultural trailer is known in practice which has an articulated, pivoting wing in an upper region of each side wall. Both opposing wings comprise a supporting frame in which a net or tarpaulin is located. The wings can each be swiveled hydraulically, so that they rest flat on a load, partially overlapping one another. The disadvantage is that the load cannot be compressed by the wings or the net. Another disadvantage is that the load is not completely covered, so it can get wet when it rains.

Furthermore, a roll-up cover net configured as a covering net is known in practice which covers a load above a substructure, such as a trailer. Due to the lightweight mesh material, compression of the load is not intended. Furthermore, the load is not protected from the effects of the weather, such as rain.

Load securing systems are known in practice in which a large, inflatable airbag is arranged in the roof region which, after being filled with air, fills empty spaces above the load and thus prevents the load from moving.

DE 202 15 675 U1 shows a structure for a substructure, such as a truck, trailer, semi-trailer, railway wagon, dump truck, or container, comprising a body and an openable roof, wherein the roof is displaceable at its edges along two longitudinal beams of the body, wherein the roof closes a roof opening between the two longitudinal beams in a closed state, wherein the roof largely exposes the roof opening between the two longitudinal beams in an open state, wherein each longitudinal beam is supported in a height-adjustable manner relative to the substructure via at least one lifting assembly, wherein the body is adjustable at least in height relative to the substructure depending on a height adjustment of the lifting assembly, wherein at least one lifting drive is provided which displaces the body together with the roof in height relative to the substructure.

DE 10 2013 201 000 A1 shows an openable roof for a substructure, wherein the roof is displaceable at its edges along two longitudinal beams, wherein the roof closes a roof opening between the two longitudinal beams in a closed state, wherein the roof largely exposes the roof opening between the two longitudinal beams in an open state.

DE 10 2014 111 765 A1 shows a structure for a substructure, such as a truck, trailer, semi-trailer, railway wagon, dump truck, or container, comprising a body and a liftable roof, wherein the roof at its edges has two longitudinal beams, wherein the longitudinal beams are supported in a height-adjustable manner relative to the substructure via at least one lifting assembly, wherein the body is adjustable at least in height relative to the substructure depending on a height adjustment of the lifting assembly, wherein at least one lifting drive is provided which displaces the body together with the roof in height relative to the substructure.

WO 2019 185 093 A1 shows a structure for a substructure, such as a truck, trailer, semi-trailer, railway wagon, dump truck, or container, comprising a body and an openable roof, wherein the roof is displaceable at its edges along two longitudinal beams of the body, wherein the roof closes a roof opening between the two longitudinal beams in a closed state, wherein the roof predominantly exposes the roof opening between the two longitudinal beams in an open state.

DE 20 2013 005 936 U1 shows a structure for a substructure, such as a trailer, which is intended for the transportation of agricultural crops, wherein a load is held down from above by a load securing unit. The load securing unit comprises two movable vertical columns, each of which is arranged in a front region of the substructure. A so-called pressing frame is mounted on the two opposing columns, wherein the pressing frame has movable bows that can be adjusted as a form for holding down the load. The disadvantage is that the load securing unit does not have an openable roof, so that loading from above is not possible. There is also no compression of the load; rather, the load is pressed from above against the floor of the substructure, thereby preventing it from moving within the substructure.

DE 20 2016 004 557 U1 shows a structure for a substructure, such as a trailer, which is intended for the transportation of agricultural crops, in which a load is covered from above by a load securing device. For this purpose, the structure comprises a horizontal support frame with covering means, such as a net or tarpaulin. The support frame further comprises lifting means which can displace the support frame in a vertical direction so that a load can be covered. A disadvantage is that the load cannot be compressed by the net. Another disadvantage is that the load is not completely covered, so it can get wet when it rains.

DE 196 37 907 A1 shows a structure for a substructure such as a truck, trailer, semi-trailer, railway wagon, dump truck or container, comprising a body and a non-openable closed roof, wherein the roof is arranged between two longitudinal beams, wherein the longitudinal beams are supported in a height-adjustable manner relative to the substructure via at least one lifting assembly, wherein the body is adjustable in height relative to the substructure at least in terms of its height depending on a height adjustment of the lifting assembly, wherein at least one electro-hydraulic lifting drive is provided which displaces the body together with the roof in height relative to the substructure, wherein the lifting drive applies a force for compressing a load projecting over the substructure in the substructure by lowering the body with the closed roof onto the substructure counter to the bias of the projecting load and compressing the load in the process.

DE 1 963 042 A shows a structure for a substructure, such as a truck, trailer, semitrailer, railway wagon, dump truck or container, comprising a body and a liftable roof, wherein the roof is arranged between two longitudinal beams, wherein the longitudinal beams are supported in a height-adjustable manner relative to the substructure via at least one lifting assembly, wherein the body is adjustable in height relative to the substructure at least in terms of its height depending on a height adjustment of the lifting assembly, wherein at least one lifting drive is provided which displaces the body together with the roof in terms of height relative to the substructure, wherein the lifting drive (a hydraulic pressure cylinder) applies a force for compressing a load projecting over the substructure in the substructure by lowering the body with the closed roof onto the substructure counter to the bias of the projecting load.

### SUMMARY

An object of the present disclosure to provide a structure for a substructure and a method for compressing a load, with which the protruding load can be reliably and easily brought to the height of the substructure and with which loading from above is possible.

According to one aspect of the present disclosure, a structure for a substructure such as a truck, trailer, semi-trailer, railroad car, dump truck or container is provided. The structure comprises a body and an openable roof, wherein the roof is displaceable at its edges along two longitudinal beams of the body, wherein in a closed state the roof closes a roof opening between the two longitudinal beams, wherein in an open state the roof predominantly exposes the roof opening between the two longitudinal beams, wherein each longitudinal beam is supported in a height-adjustable manner relative to the substructure via at least one lifting assembly, wherein the body is adjustable at least in height relative to the substructure depending on a height adjustment of the lifting assembly, wherein at least one lifting drive is provided which displaces the body together with the roof in height relative to the substructure. The structure is characterized in that the lifting drive applies a force in the substructure for compressing a load protruding beyond the substructure by lowering the body with the closed roof onto the substructure against the pre-tension of the protruding load. This has the advantage of ensuring that the often prescribed covering of the substructure for road transport and the maximum permissible height in road traffic are adhered to. On the one hand, the load is subjected to a precisely defined force from above and thus compressed, and, on the other hand, an exact maximum height of the substructure with the structure is always ensured. Surprisingly, the openable roof, which is arranged or stretched in the middle of the body, absorbs the forces that arise when the load is compressed. Although the openable roof is a movable roof, it is still possible to compress the load with this openable roof.

Agricultural bulk goods such as grain, silage, compost, hay, straw, etc. can be considered as a load. Furthermore, loads having a relatively low density, such as insulation materials, paper and cardboard boxes, can also be transported and compressed, because the structure is generally used to compress, compact and hold down the load. A further advantage is that the structure can be sealed completely, so that the load is always protected from rain, wind and other weather influences.

The roof preferably takes up more than half, preferably more than three quarters and particularly preferably more than four fifths of the surface of the body. This is preferably achieved by the roof being displaceable between the longitudinal beams. It is possible that for this purpose the roof comprises more than one roof segment. The roof segments can also be displaced in opposite directions to open the roof.

Expediently, the surface of the closed roof corresponds approximately or completely to the surface of the upper opening of the substructure, so that the roof those forces for compressing the protruding load. This is what distinguishes the openable roof from inspection hatches or the like.

The body of the structure conveniently forms a preferably rigid frame within which the roof can be opened and closed. The frame includes the two longitudinal beams, but also other parts, such as cross members, etc., which give the frame stability.

Since the load is loaded via the upper roof opening, tarpaulins or other covering elements can also hang downwards from the body, for example inside or preferably outside the substructure, in order to advantageously close or seal the region between the substructure and the longitudinal beam (when the body is raised). In the simplest embodiment, a side tarpaulin is attached between the longitudinal beam and the substructure, e.g., buttoned or arranged in the manner of a sliding curtain over tarpaulin suspension rollers to allow an opening. When the body is lowered, the side tarpaulin folds. It is possible to configure the side tarpaulin as an elastically stretchable web material, which then applies a restoring force component to the structure in the lowering direction. Alternatively, the side tarpaulin can be configured in the manner of a bellows in order to achieve a defined unfolding and refolding. It is possible to leave the tarpaulin hanging in the substructure while the substructure is being filled and only pull it out of the substructure when the body is lifted so that the load is guided into the substructure.

According to a particularly preferred embodiment, the web material of the side tarpaulin extends, when the structure or body is lowered, to approximately the level of the floor of the substructure or to the loading platform, so that the side tarpaulin can be fastened in a known manner with straps and hooks. In this case, the side tarpaulin covers one wall of the substructure.

Preferably, each of the two longitudinal beams is supported in a height-adjustable manner relative to the substructure via at least two stanchions. By means of the at least two stanchions, the longitudinal beam can be raised parallel to the substructure or raised to different extents at its two ends.

The stanchions expediently have a stanchion lower part assigned to the substructure and a stanchion upper part, which is displaceable relative to the stanchion lower part and is assigned to the longitudinal beam. Here, one of the two stanchion parts guides the other in the manner of a linear guide, as is known with so-called sliding stanchions.

In a preferred embodiment, it is provided that the lifting drive is configured as a stanchion drive or comprises a stanchion drive which displaces at least one stanchion upper part in height relative to the corresponding stanchion lower part. Accordingly, the longitudinal beam can be raised and lowered in an advantageous manner by the stanchion drive, wherein the stanchion drive applies a force to compress a load protruding beyond the substructure into the substructure during lowering, in which the body and in particular the closed roof can be lowered over the substructure against the prestressing of the projecting load until the body reaches the substructure.

Expediently, a stanchion is arranged in each corner region of the substructure. Furthermore, each of the four stanchions preferably has its own stanchion drive. The advantage is that each stanchion can be individually adjusted vertically in height so that a user can individually adjust both the vertical position of the stanchion and a defined lifting force that the particular stanchion delivers. Furthermore, the structure can also be displaced by the stanchion drives, so that it forms an angle to the horizontal, for example by lifting only one of the two longitudinal beams, or by lifting the longitudinal beams only at one end each. However, it is quite possible to provide stanchions in positions other than the corners of the substructure.

Preferably, each of the stanchion drives can be actuated independently of the other stanchion drives. It is an advantage for the user that each stanchion can be adjusted precisely in height using its own stanchion drive. This makes it possible for the user to set a defined lifting force as well as a defined vertical position for each stanchion.

It is expedient, that multiple preferably all stanchions of a longitudinal beam and preferably all stanchions assigned to the body can be moved simultaneously in height. When a user sets and activates a control and regulation technology for the stanchions to “simultaneous,” all stanchions are moved simultaneously in a vertical direction at the same speed and/or with the same lifting force. It is also possible to use an auto-home function, which always moves the stanchions to a defined starting position when activated, so that all stanchions have the same height. The advantage is that jamming or blockage is always prevented, which means the structure is reliable, low-maintenance, quiet and durable.

Conveniently, the lifting drive is selected from the group comprising: pneumatic drives, hydraulic drives, electric drives, spindle drives, rack and pinion drives, cable pull drives, driven scissor kinematics, driven link kinematics and combinations of the above. Depending on the application and cost-effectiveness, the aforementioned drives may be considered for a stanchion drive. Accordingly, the structure and the stanchion are characterized by increased flexibility.

In an advantageous embodiment, the driven link kinematics can be configured as multi-joint kinematics, for example in that the structure, for example each longitudinal beam, is assigned a four-bar arrangement with two links, each of the two links being connected at a lower end in an articulated manner to the substructure or to a part assigned to the substructure, and wherein each of the two links being connected at a lower end in an articulated manner to the substructure or to a part assigned to the substructure, and wherein each of the two links being connected at an upper end in an articulated manner to the structure or to a part assigned to the structure, in particular a longitudinal beam in each case. The four-bar arrangement pivots the entire structure upward and at the same time into a region a little way outside the substructure, so that the region in which the folded roof is provided is advantageously simultaneously displaced away from an upper opening in the substructure without the longitudinal beam protruding beyond the substructure in the ready-to-drive state. In this case, the body in a raised state can be held in a favorable implementation above the level of the lowered state without the need for locking. The body is moved by pivoting it upward, the height of the pivot depending on the length of the links, thus enabling the protruding load to be run over in a favorable manner. If the links are assigned to the short sides of the structure and substructure, the structure can be placed next to a side wall of the substructure when opened, for example by pivoting it by preferably 90° or 270°.

The driven link kinematics can be configured in another advantageous embodiment as parallelogram link kinematics, for example by a parallelogram link arrangement having two links being assigned to the structure, for example to each longitudinal beam, each of the two links being connected at a lower end in an articulated manner to the substructure or to a part assigned to the substructure, and wherein each of the two links being connected at a lower end in an articulated manner to the substructure or to a part assigned to the substructure, and wherein each of the two links being connected at an upper end in an articulated manner to the structure or to a part assigned to the structure, in particular to a longitudinal beam in each case. Advantageously, the lifting movement is provided by the first half of the pivoting about the lower link axes, which is followed by a displacement into a parking position by the second half of the pivoting about the lower link axes. In the parking position, the structure is favorably placed back on the substructure, meaning that the body does not get in the way of loading and at the same time no locking is required in the raised position. Furthermore, this allows the part of the structure in which the folded roof is folded to be moved outside the upper opening of the substructure, so that the upper opening of the substructure is practically completely exposed without the longitudinal beams protruding beyond the substructure when the structure is lowered. If the control arms are dimensioned to be sufficiently long, approximately up to half the length of the side wall of the substructure, in any case longer than a tenth and preferably longer than a seventh of the length of the side wall of the substructure, a high apex of the swivel movement is achieved, whereby a high protrusion of the load above the upper opening can be moved across. It is advisable to close the roof when the swivel movement of the body has reached its zenith, because in the parking position the protruding load gets in the way of closing the roof.

A favorable variant provides, for example, that the stanchion has two mutually guided stanchion lower parts and stanchion upper parts, which only allow a vertical mutual displacement. The stanchion drive displaces the upper part of the stanchion connected or coupled to the longitudinal beam relative to the lower part of the stanchion connected to the substructure or a chassis, allowing the drive to extend or retract the stanchion. The stanchion drive can advantageously be a pneumatic or hydraulic piston-cylinder unit, one end of which is connected to the stanchion lower part and the other end to the stanchion upper part in order to be able to apply both compressive forces (e.g., for lifting) and tensile forces (e.g., for lowering).

A hydraulic drive is particularly preferred because it moves over a defined path without slippage. However, it is also possible to provide a spindle drive in which a spindle rod is assigned to one of the lower and upper parts of the stanchion and a spindle nut is assigned to the other of the lower and upper parts of the stanchion, and the spindle rod is driven by an electric motor. The solution with a spindle drive requires little setup effort and allows easy control via the electric motor.

According to another alternative, a motor assigned to one of the two stanchion parts, the stanchion lower part and the stanchion upper part, can also mesh with a gearwheel along a rack or perforation assigned to the other of the two stanchion parts and thus displace the two stanchion parts relative to one another in height.

A particularly simple alternative to a stanchion drive is provided if a driven scissor kinematics are provided as a lifting drive. The driven scissor kinematics comprise, for example, a scissor lift table which is arranged in the region of at least one edge between the substructure and the structure, for example on the front wall and/or on the rear wall of the substructure, whereby the body can be raised or lowered in the region of the end of the longitudinal beams. Alternatively, a scissor lift table can also be provided between the side wall of the substructure and the longitudinal beam. Yet another solution provides that the upper table of the scissor lift table is formed by the body. In this case, the raising or lowering of the scissor lift table can be advantageously achieved by means of a linear drive that axially displaces one end of the scissors. The drive can be located in the region of the body, but is preferably arranged in the region of the substructure for better accessibility.

It is possible to arrange the scissor lift table not on top of the substructure, but on the bottom of the substructure. Although this increases the height of the scissor lift table, a greater force can also be applied to the body due to the resulting transmission ratio.

According to a preferred embodiment, the longitudinal beam is connected to the lifting drive via coupling kinematics, which allow tolerance compensation. The advantage of coupling kinematics with integrated tolerance compensation is that tilting is prevented when the roof is adjusted in height. This ensures that the structure is always functional and reliable. Furthermore, when the structure is tilted, the coupling kinematics can compensate for the path caused by the height difference, for example, between the front and rear stanchions, and effectively prevent tilting.

According to one embodiment, the coupling kinematics are selected from the group comprising: ball joints, joint connectors, slot-pin combinations, bolt-eye combinations, hinges and combinations thereof. In order to ensure the functionality of the coupling kinematics, sturdy and reliable component elements are used. Furthermore, they are low-maintenance and cost-effective and are characterized by a high product longevity. The coupling kinematics must also be able to transmit tensile forces if the structure is to be pulled onto the substructure counter to the restoring force of the protruding load. Ball joints are particularly useful for this purpose, as they can also compensate for any inclination of the structure relative to the substructure.

According to a first preferred embodiment, the openable roof comprises a tarpaulin. The advantage of a tarpaulin is that it is inexpensive, lightweight and easy to install or easy and quick to replace and weatherproof. Furthermore, a tarpaulin can be flexibly and individually arranged on the structure and can be flexibly folded or rolled up. The tarpaulin on a closed roof of the structure advantageously protects the load from rain, wind and other weather influences, so that the load always arrives at its destination dry.

According to a further preferred embodiment, the openable roof comprises a net panel. The net panel is also inexpensive, lightweight and easy to install and can be easily and quickly replaced and is sufficient to compress the load depending on the mesh size. Furthermore, a net panel can be flexibly and bendably arranged individually to suit the structure and can be flexibly folded or rolled up.

According to a further preferred embodiment, the openable roof comprises a web-shaped cover which has a high tear resistance. The sheet-like cover can also be made of expanded metal or other inelastic components that do not give way under the load of the lifting drive.

Preferably, the tarpaulin is connected to each of the two longitudinal beams via multiple bows with sliding carriages at each end. In order for the tarpaulin to be opened or closed like an accordion, for example, it is connected to the bows. This means that the tarpaulin can be easily displaced along the longitudinal beams using the bows. Such folding roofs, in which the tarpaulin is connected to the longitudinal beams via bows, are well known and have a high resistance to dynamic loads in driving operation. Surprisingly, it turns out that the sturdy construction of the folding roof also makes it possible to absorb the forces that occur when the load protruding beyond the open upper opening of the substructure is compressed, so that, contrary to all expectations, a structure with a sliding roof allows the load to be compressed.

It is advantageous if the adjacent bows are coupled to one another via tarpaulin folding aids, which lift the tarpaulin when the folding roof is pushed together. It is possible that the tarpaulin folding aids are in turn equipped with a lifting bow, which further improves the folding of the tarpaulin.

It is also possible to form the bows from two telescopic bow halves which, for example, have a certain amount of play via an elongated hole and a connecting pin, with which they can perform a change in length and with which they can adapt to the increased distance between the longitudinal beams when one longitudinal beam is raised and one longitudinal beam is lowered. For this purpose, it can further be advantageously provided that the sliding carriages are connected to the bow via joints, whereby the sliding carriages do not change their position relative to the longitudinal beam, but the bow adjusts relative to the sliding carriages.

According to an alternative embodiment, the openable roof has multiple roof elements coupled to one another, which can be folded together accordion-like to open the roof and when the roof is closed close the roof opening lying next to one another. The advantage of roof elements is that they have a higher rigidity, which means that the roof elements can absorb even higher forces without bending significantly. Furthermore, roof elements as well as side wall elements offer greater protection against break-in.

Each longitudinal beam expediently comprises a longitudinal beam base part which is assigned to the lifting drive and a longitudinal beam guide part which is assigned to the roof. Furthermore, the longitudinal beam guide part is displaceable at least in a direction transverse to the extension of the longitudinal beam with respect to the longitudinal beam base part. The advantage is that the resulting longitudinal beam allows mobility transversely to the direction of displacement of the roof and accordingly, when the structure is tilted, the path caused by the difference in height between the two longitudinal beams can be compensated and tilting can be effectively avoided. Such a solution is described in WO 2019 185 093 A1, the disclosure of which is hereby incorporated into the application by reference.

Overall, it is advantageous that the lifting drive comprises an overload protection device that prevents the body from being closed with a force that exceeds a threshold value for the load on the roof. This advantageously avoids damage to the stanchion drive and the roof. In the event that the load is less compressible than expected, or has already been compressed once and therefore cannot be compressed further as often as desired, this prevents the lifting drive from being overloaded or the openable roof, which is supposedly the weakest link in the structure, from being damaged.

Preferably, the overload protection is selected from the group comprising: a slip clutch, a pressure sensor, a torque limiter, a current limiter, a temperature switch, a pressure relief valve, a safety clutch and combinations thereof. The aforementioned components ensure in an economical way that the overload protection functions reliably, robustly and with low maintenance.

If the stanchion drive comprises an electric motor, the overload protection can, for example, be configured in such a way that a slip clutch is provided between the output shaft of the motor and the driven part. If the force required to lower the structure is too high, the slip clutch slips and the movement of the stanchion parts stops.

According to a preferred embodiment, a distance sensor is provided which emits a signal when the roof is completely lowered. This means that a user can immediately know when the roof is completely lowered, even in poor visibility conditions, for example at night or due to the height of the structure. This information is important in order to prevent loads from escaping and/or exceeding the maximum permissible ride height.

According to a preferred embodiment, a locking assembly is provided which mutually locks the lifting drive or the parts relatively displaced by the lifting drive, e.g., the upper part of the stanchion relative to the lower part of the stanchion, in particular when the roof or the body is completely lowered or when the roof or the body is at least partially raised. This advantageously prevents unexpected height adjustment or unexpected opening. Furthermore, the locking assembly helps to hold the load down permanently and thus prevent it from slipping.

With a motorized or hydraulic stanchion drive or powered scissor kinematics, the drive can be switched off after reaching the substructure without the roof being raised again by the compressed load like a spring. Furthermore, shocks during travel are not transmitted to the stanchion drive. It is understood that the locking assembly can also be configured to be electrically actuated, so that the control unit only switches off the motor after it has been locked and first allows the locking assembly to disengage before the stanchion parts are displaced, e.g., via a locking pin that is actuated by a magnet. In such a case, the control unit advantageously provides that in order to release the locking pin, the body is first displaced a little way in the direction opposite the planned direction of displacement.

Expediently, the roof is assigned a roof drive which enables the roof to be opened and closed. The roof drive advantageously comprises a motor, so that a user can open and close the roof quickly and easily. Furthermore, it is preferably provided that the drive is remotely controllable.

According to a further preferred embodiment, the two longitudinal beams are connected to one another in the region of at least one of their ends by a cross member which is preferably variable in length. This advantageously prevents jamming and/or possible damage to the structure. It is possible to make the cross member telescopic so that it can follow an inclination of the structure and the associated change in length. It is understood that a cross member can also be coupled to the longitudinal beams at both of its ends.

According to a preferred embodiment, the roof is configured to be foldable for opening. Furthermore, the folded roof can be pushed together in one end region of the longitudinal beams, thereby clearing the roof opening, and the folded roof also projects upwards relative to the longitudinal beams. This advantageously creates the largest possible opening for a loading space in order to facilitate filling of the loading space. Furthermore, during the opening process, the roof is displaced away from the load in an upward direction, so that entangling of the roof with the load or possible damage to the roof is advantageously avoided. It is possible to enlarge the roof opening if the longitudinal beams have an axial overhang over the substructure, into the region of which the tarpaulin is pushed. The axial projection can also be achieved by a telescopic longitudinal beam or by a longitudinal beam attachment which, if required, is attached to the longitudinal beam to extend it axially.

According to an alternative embodiment, the roof is configured to be foldable for opening. The folded roof can be pushed together in one end region of the longitudinal beams, thereby clearing the roof opening, with the folded roof protruding downwards relative to the longitudinal beams. This again has the advantage of allowing the largest possible opening of the loading space. Now, when the roof is opened, it is displaced in a direction toward the load, so that the opened roof now protrudes downward. One advantage is that the structure can also be used in very tight spaces, for example in a building such as a hall or barn. Furthermore, the downwardly projecting roof can be equipped, at least in portions, with tool elements, for example in the form of a rake, in order to mix the load on the surface and/or distribute it evenly. This arrangement has two main advantages: Firstly, the height-adjustable structure can be raised to open or close the roof, so that the roof protruding from the longitudinal beams does not collide with the load. Secondly, when the roof is closed, the roof components rest on the longitudinal beams and are well supported when the structure is lowered by the lifting drive, so that the load is compressed particularly effectively and the roof parts are protected.

A favorable further development provides that the roof projecting downward has a net panel or alternatively a sheet-like tarpaulin which can hang down loosely and which is preferably supported by bows against the longitudinal beams. It is possible to attach the net panel to the bows so that it is carried along by the bows when the roof is closed. Alternatively, the net panel can also be wound onto a roll of the body. By lifting the body, not only is the protruding load advantageously covered, but the folded roof is also pulled out of the load. Alternatively, the openable roof can be made up of roof elements folded together like an accordion and protruding downward.

It is particularly advantageous to additionally cover a level above the roof with an upper tarpaulin, e.g., wound on a roller, in order to obtain a weatherproof cover, wherein the upper tarpaulin does not absorb any forces to compress the load and can therefore have a lightweight design. The upper tarpaulin can, for example, be connected to an end running part of the roof so that it is carried along when the roof is closed. The roller can, for example, be pre-tensioned with a spring in the wind-up direction.

Preferably, the lifting drive actively compresses the load by applying a downward force via the body, in particular into the roof. However, it is also possible for the lifting drive to lift the body, possibly counter to the bias of a spring device, such as a coil spring or a compressible gas spring, and for the body to compress the load during its lowering movement toward the substructure under the load of its own mass or, in the case of a spring device, additionally under the restoring force of the spring device. In this case, the lifting drive can be operated by a motor or by hand to lift the body. The mass or the restoring force of the spring device are then dimensioned such that they are sufficient to compress the load. It can happen that lowering the body onto the empty substructure causes an intense impact.

According to a favorable embodiment, it is provided that the body has an attachment for a manual tensioning device, for example an eccentric lever device or a knee lever device or a rope laid over a pulley, wherein the body being displaceable in the direction of the substructure by actuating the manual tensioning device. This eliminates the need for a motor and the associated electrical, hydraulic or pneumatic lines. Rather, the body is lowered—and possibly also raised—together with the roof by the manual tensioning device. The rope can be operated with the pulley via a roller with a crank, but it is also possible to use a portable drive, such as a cordless screwdriver or the existing winch of a towing vehicle. The eccentric lever device or the knee lever device can also be used to lock the body against the substructure. Conveniently, the substructure also has an attachment point for the manual clamping device, so that clamping between the substructure and the body is possible. The manual clamping device can also be firmly connected to the relevant attachment.

The structure is expediently used for compacting a load protruding above the substructure, in particular harvested crops. Harvested goods include, for example, bulk goods such as grain, silage, compost, straw and the like. Overall, these have a relatively low density, which means that they can be compressed on the one hand by means of the structure and on the other hand can be held down. Other goods mentioned above may also be considered as a load.

According to one aspect of the present disclosure, a method is provided for compressing a compressible load which protrudes beyond an upper opening of a substructure, wherein the substructure has a structure with an openable roof, comprising the steps of: raising the structure with the roof open relative to the substructure; closing the roof above the upper opening and above the protruding load; and lowering the structure with the roof closed while compressing the load until the substructure is reached and the upper opening of the substructure is closed. The above method can be repeated multiple times, whereby a process of compressing the load results in a reduction of hollow spaces within the load, thereby maximizing the use of the loading space of the substructure. This has the advantage that transport is economical, efficient and safe. The method also makes it possible to close the upper opening of a substructure where the load protrudes beyond the upper opening and to avoid a displacement of the roof below the load, which would result in the load being pushed over the substructure and thus a loss of load. Rather, the structure can be lifted with the roof open and then closed completely without collision with the protruding load and without resistance or loss of the load. Accordingly, the roof can be closed just as easily as with an unloaded substructure. The structure with the roof closed is then moved toward the substructure in a similar way to a press ram, whereby the openable roof surface substantially compresses the load and the volume of the substructure is filled with load in a particularly compact manner. It is possible to move the substructure away from road traffic, e.g., on a field, while the at least partially open roof is being raised and while the closed roof is being lowered, so that the resulting shaking movements already cause an initial collapse of the load. When the structure reaches the substructure, it is ensured that the substructure and structure comply with the maximum height permitted for road traffic and that the load is covered as best as possible, which means that dust or particles from the load do not escape during the journey and the load is also protected against precipitation and other weather influences.

According to a preferred embodiment, the raising and/or lowering of the structure is carried out by means of a lifting drive, which effects a height adjustment of the structure relative to the substructure. The lifting drive advantageously provides both the force to lift the structure and the force to compact the load. Accordingly, high forces can be applied and a high degree of compression of the load can be achieved. The lifting drive can be configured as described above.

Expediently, the structure comprises two longitudinal beams arranged on either side of the upper opening. Furthermore, the openable structure comprises a folding roof which is displaceable along the two longitudinal beams. This facilitates a simple and reliable construction, allowing the largest possible opening to be created, allowing a load to be filled into the substructure from above in a simple and quick manner. Furthermore, this advantageously promotes reliable opening and closing of the roof. This means that the structure, including the longitudinal beams, can be raised relative to the substructure, the longitudinal beams resting on the side walls of the substructure when the structure is lowered. Preferably, the longitudinal beams have a recessed, longitudinal groove which is adapted to the thickness of the relevant side wall, whereby the longitudinal beam can be brought close to the substructure without a gap.

Overall, it is advantageous that each longitudinal beam can be adjusted in height relative to the substructure by at least two stanchions. The advantage is that the dead weight of a longitudinal beam is distributed over at least two stanchions, which advantageously ensures stability and uniform displacement of the longitudinal beam. Preferably, a stanchion is coupled to the longitudinal beam in the end region of each longitudinal beam, so that the stanchions are height-adjustable corner stanchions. It is possible that the side wall of the substructure curves slightly upward from the stanchions toward the middle in order to center the longitudinal beam a little when it is lowered.

According to a preferred embodiment, one or more of the stanchions are adjusted in height together or individually in order to raise and/or tilt the structure. For a user, this advantageously increases flexibility with regard to compressing and displacing the load, because in practice a load is rarely evenly distributed directly after filling into a substructure, but rather there is at least one heap of load in a substructure. In this respect, it is always possible to adjust the roof according to the load. The combined adjustment of all stanchions allows the load to be compressed evenly during lowering. However, it is possible to adjust only one or some of the stanchions vertically within certain limits specified by coupling kinematics. For example, the stanchions assigned to one longitudinal beam can raise it while the other longitudinal beam remains in the lowered position. This allows a surface to be formed that is inclined toward the upper opening when the roof is closed, and the substructure is loaded by filling it via the space between the substructure and the raised longitudinal beam.

Conveniently, one or more of the stanchions is assigned a stanchion drive as a lifting drive, which effects the vertical displacement of a stanchion upper part relative to a stanchion lower part. Preferably, each stanchion has its own assigned stanchion drive, e.g., a hydraulic piston-cylinder unit, with one end assigned to the stanchion lower part and the other end assigned to the stanchion upper part. The two stanchion parts together define a linear guide in that one of the two stanchion parts can be moved in the axial direction along a guide track of the other of the two stanchion parts, while in the two directions transverse to the axial direction it allows at most a small amount of play in order to allow displacement largely without friction.

The stanchion drive conveniently displaces the structure by moving the upper part of the stanchion assigned to each one in one direction onto the substructure until the load is compressed or a threshold value for a displacement force to be applied by the structure is reached. This advantageously ensures that if the threshold value is exceeded, the compression of the load is stopped in order to avoid damage to the structure or its individual parts. Once the structure reaches the substructure, the structure does not need to be lowered any further.

The stanchion drive advantageously has a minimum force that enables it to withstand defined loads, whereby a load can be compressed. In order to avoid damage to the stanchion drive or to the structure as a whole, there is advantageously a threshold value that acts as a kind of limit switch for the stanchion drive, so that the displacement of a stanchion can be reliably stopped if this threshold value is reached or exceeded.

According to a favorable embodiment, a latch locks the upper part of the stanchion relative to the lower part of the stanchion when the structure has reached the substructure (lower end position) or when the structure has reached a desired extension height (upper end position or intermediate position), and after locking, the stanchion drive is switched off. Once the load is compressed, the structure can be locked in the lowered position and the drive switched off, saving power and/or energy. The locking can be achieved by means of a bolt which, when the structure is lowered, passes through aligned holes in the two stanchion parts, for example pushed forward by an electromagnetic actuator or a return spring. Before the roof is raised, the latch must be unlocked again. This also ensures that the structure cannot easily be pried upward by third parties when the substructure is parked.

An advantageous embodiment is characterized in that the lifting drive comprises at least one first, e.g., front, lifting drive unit and at least a second, e.g., rear, lifting drive unit. The lifting drive unit is supported at one end against the substructure and at the other end against the structure. In the case of a stanchion drive, the stanchion drive of the front stanchion of a longitudinal beam is the front lifting drive unit and the stanchion drive of the rear stanchion is the rear lifting drive unit. In the case of driven scissor kinematics, a front scissor lift table can be assigned to the two longitudinal beams on the front wall and a rear scissor lift table can be assigned to the two longitudinal beams on the rear wall. In the case of alternative driven scissor kinematics, the first lifting drive unit can be assigned to one longitudinal beam and the other lifting drive unit to the other longitudinal beam. The first and second lifting drive units advantageously introduce both tensile forces and compressive forces into the substructure and the structure, whereby the raising and lowering of the structure is advantageously accomplished by the same lifting drive.

According to a further preferred embodiment, before the step of lowering the structure, the structure is arranged in a horizontal plane above the substructure, i.e., substantially parallel to its upper opening. This helps the structure to press evenly on a load from above, thus preventing tilting and ensuring that the load is compressed evenly.

Preferably, to open or close the roof, the structure is inclined at an angle in the direction of the corresponding opening or closing movement. The advantage is that the roof's own weight is used to open or close the roof as a result of the structure being tilted, which makes it easier to open or close the roof.

According to one embodiment, the substructure has a flap for unloading the substructure. Preferably, the roof is opened and/or the structure is raised before opening the flap. This allows the flap to swing into a region that is closed by the roof. Furthermore, the load is slackened, making it easier to evacuate it from the substructure.

According to a further preferred embodiment, a controller controls at least one of raising and lowering the structure, opening and closing the roof, and opening and closing a flap of the substructure. Integrated control and regulation technology increases operating comfort for the user and also ensures consistent force input and protection against incorrect operation. Furthermore, the aforementioned control and regulation technology can be configured to be remotely controllable and automatable, so that, for example, railway wagons or the like can be equipped with the above structure and loaded or unloaded with a load. The control system allows a sequence of partial movements to be coordinated with one another, and the structure, the roof, the latch and/or the flap to be moved simultaneously in a desired sequence. An operator can then choose between multiple complex functions such as “open,” “close” and/or “unload,” while the control system issues the corresponding control commands to the components of the structure and substructure.

According to another preferred embodiment, the step of lowering the structure comprises multiple sub-steps in which the structure is raised and lowered again. In this case, the compression of a load is advantageously repeated until a defined degree of compression is reached and a loading space is thus fully utilized. This ensures economical, safe and efficient transportation. Furthermore, intermittent pressure peaks in the load lead to a more even distribution of the load in the substructure, because the load flows in the direction of lower pressure.

Overall, it is advantageous that the step of lifting the structure with the roof open relative to the substructure takes place after the substructure has been loaded with a load, preferably with bulk and/or free-flowing crops, preferably via the upper opening. The advantage is that the structure should not get in the way while the substructure is being filled, so that the substructure can be filled free of any disturbing elements. As soon as a pile of a load protrudes above the substructure, the structure can be lifted with the roof open. By means of the roof, the heap of the load can be distributed so that the load is evenly distributed in the substructure. The roof is then closed and the structure is lowered onto the load so that the compression process can take place. This is preferably repeated multiple times until the loading space is completely filled to ensure economical and efficient transportation of the load.

According to a further development, the structure has a load sensor which detects pressure or other parameters of the load on the structure. The measured values of the load sensor can be transmitted to the controller to compare them to the associated threshold values.

Preferably, the speed and/or force with which the structure is lowered is controlled depending on the parameters detected by the load sensor. This control advantageously ensures reliable and very safe operation of the structure for compressing loads and, depending on the measured value, allows the structure to be lowered onto an empty substructure more quickly than if it is filled or overfilled with loads. Furthermore, the structure is advantageously suitable for automation to compress a load in a substructure.

According to a further preferred development, the structure has a distance sensor which detects a distance of the structure from the substructure. The measured values of the distance sensor can be transmitted to the controller to compare them to associated threshold values. In this way, the speed at which the structure approaches the substructure can be reduced near the substructure. Furthermore, the measured value can be used for a signal that indicates whether the structure is at a height that does not exceed the maximum construction height for road traffic. The distance sensor can also be used to detect a maximum height of the structure or a maximum inclination of the structure against the horizontal.

Preferably, the speed and/or the force with which the structure is lowered is controlled based on the distance detected by the distance sensor, preferably by the control system. In this respect, damage can be ruled out, making the structure reliable and safe to operate.

According to a further development, the structure has a closing sensor which detects whether the roof is closed and/or whether the structure is completely lowered. With the roof open, participation in road traffic is not permitted, even if the maximum height of the vehicle is observed. Preferably, the locking sensor delivers a corresponding road traffic readiness signal. The user advantageously receives a signal which immediately informs him that the vehicle or the substructure is ready to drive so that a time-consuming check of the roadworthiness of a structure is no longer necessary, which can save time and costs.

Conveniently, all of the aforementioned sensors relating to the condition of the structure are connected to the control system, which uses the measured values to regulate the method steps.

Preferably, the introduction of the load into the loading space of the substructure is provided as a separate step. This step can be done before or after the step of lifting the structure with the roof open. The open roof allows the load to be placed in the loading space, even when the structure is resting on the substructure. If the load does not extend beyond the upper opening of the substructure, the roof can be closed without lifting the structure. However, it is also possible to lift the structure before the load is placed into the loading space of the substructure. The latter solution is particularly advantageous when raising the roof means that the folded part of the roof no longer partially closes off the upper opening.

It is advisable to open the roof as a first step while the structure is still closed. However, it is possible to open the roof only when the structure is already completely or partially opened.

According to a favorable embodiment, a method is provided for compressing a load which can be introduced into a loading space of a substructure, such as a truck, trailer, semitrailer, railway wagon, dump truck, or container. The method comprises an openable roof made of weather-resistant material, which is at least partially opened, so that the loading space of the substructure is accessible. The load is then placed into the loading space of the substructure. Furthermore, the method comprises two longitudinal beams, each of which is supported on at least one stanchion and which are connected to the roof, wherein the roof being displaceable along the two longitudinal beams, and is raised by at least one stanchion drive so that at least one of the two longitudinal beams is arranged at least in portions above the load introduced into the loading space of the substructure. The roof is then closed, and the stanchion drive displaces the longitudinal beams downward, so that the roof compresses the load and holds it down permanently. In the above method, a load is compressed from above and, if necessary, held down during transport, whereby the method and the structure have two significant advantages. On the one hand, the loading space is used to the maximum, so that transport is always economical and efficient, and on the other hand, the load can be transported on the road without loss thanks to a cover that allows safe transport. Furthermore, the closed roof provides optimum weather protection so that the load always arrives dry.

Conveniently, the roof is raised and/or lowered in an at least partially open position. In addition, the roof is conveniently raised and/or lowered in a fully closed position. For the user, this advantageously offers increased flexibility, as the structure and roof can be displaced in any situation.

Preferably, the roof comprises a tarpaulin. A tarpaulin can be attached or replaced relatively easily to the roof frame of a structure. Furthermore, a tarpaulin is low in weight, and a tarpaulin is flexible, bendable and can be folded like an accordion. Furthermore, a tarpaulin is also easy to clean and reusable.

Conveniently, the tarpaulin is made of a weather-resistant material. To protect the load from moisture, rain, snow and other weather influences, the tarpaulin must be made of a sturdy and weather-resistant material.

According to a preferred embodiment, the tarpaulin is connected to each of the two longitudinal beams via multiple bows, each with end sliding carriages. So that the tarpaulin can be opened or closed like an accordion, for example, it is connected to bows. This means that the tarpaulin can be easily displaced along the longitudinal beams using the bows.

According to a preferred further development, the tarpaulin is connected to each of the two longitudinal beams via multiple bows, each with rollers at the end. Depending on the application, rollers can be used instead of carriages, which are both reliable and sturdy. Rollers have the advantage that they are less susceptible to jamming with free-flowing bulk materials. As a rule, the carriages have multiple rollers.

Overall, it is advantageous that the tarpaulin is folded up when the roof is opened and unfolded when it is closed. The tarpaulin is conveniently folded or unfolded like an accordion. This facilitates reliable opening and closing of the tarpaulin.

Preferably, opening the roof comprises folding the roof and closing the roof comprises unfolding the roof. Folding can be done by folding a tarpaulin, but a net panel can also be provided instead of the tarpaulin, or, instead of a flexible roof, multiple roof portions that can be folded together like an accordion are provided.

According to one alternative embodiment, the tarpaulin is made of a cut-resistant material. A chopped crop, such as corn silage, can have sharp edges, which result in the tarpaulin material being broken or cut. Therefore, the tarpaulin is made of a tear-resistant and cut-resistant material.

According to a further embodiment, the tarpaulin comprises a cut-resistant material at least in portions. For cost reasons, the tarpaulin cannot necessarily be made entirely of cut-resistant material, but only in the portions where contact with the crop may occur.

According to a favorable further development, the tarpaulin is a composite made up of multiple layers of material. In order to ensure that the tarpaulin has the greatest possible cut and tear resistance, a composite made up of multiple layers of material is used. These can at least be sewn and/or glued together. Advantageously, the durability of the tarpaulin is increased by means of a composite, especially when the tarpaulin rubs along the load during an opening or closing process. Furthermore, the load is optimally sealed and protected from rain and other weather influences by means of the sturdy tarpaulin.

The lifting drive is expediently configured as a linear motion drive which can dynamically raise and lower a particular longitudinal beam at least in portions. In addition, the lifting drive offers precise positioning as well as individually adjustable speed ranges for moving the particular longitudinal beam. For example, a user can specify a speed profile for both raising and lowering a longitudinal beam, so that, for example, in a region of an end stop the longitudinal beam is displaced or braked at a reduced speed. There are at least two end stops. The first end stop is reached when the longitudinal beam is fully raised, at least in portions. The second end stop is reached when the longitudinal beam is completely lowered, at least in portions. The lifting drive advantageously has a so-called soft-close system, which dampens the displacement of the longitudinal beam shortly before reaching an end stop.

Preferably, the lifting drive is hydraulically, pneumatically or electrically driven. The advantage is that the above types of lifting drive can be automated on the one hand and can withstand high loads on the other. The lifting drive can be advantageously automated using limit switches which, when activated, stop a movement process of the lifting drive, for example. Limit switches are arranged at precisely defined positions with specific distances in the structure so that a defined travel path of a lifting drive can always be registered and controlled and regulated via the limit switches. This means that the longitudinal beams are always displaced precisely, robustly and reliably.

According to a preferred embodiment, the lifting drive is integrated in the stanchion. To avoid damage to the lifting drive, particular attention must be paid to ensuring that the lifting drive does not come into contact with the load. The lifting drive is advantageously arranged in a dust-and waterproof housing. Furthermore, integration into a stanchion ensures a compact design so that the loading space can be used to the maximum in order to transport the load economically and efficiently.

According to a further preferred embodiment, the lifting drive can be retracted and extended telescopically. Overall, this increases the compactness of the entire structure, and the lifting drive can also withstand very high forces. The telescopic drive can also be provided outside the substructure, for example in the region of the front wall or the rear wall of the substructure, and can then be supported on a part supporting the substructure, such as the axles or a loading platform.

According to a further preferred embodiment, the structure is raised and/or lowered together with one of the longitudinal beams. The structure is tilted lengthwise and displaced upward. This advantageously provides flexibility for a user, for example when filling the substructure with a crop.

Expediently, the roof comprises at least one end running part. The end running part advantageously gives the roof increased stability, making it easier to open and close. Furthermore, the roof can be locked via the end running part.

It is useful to raise and/or lower the structure together with the end running part. This increases the flexibility regarding the loading and compression of the load. Furthermore, this supports the unloading process, because disruptive components can be relocated, so that loading or unloading can be carried out quickly.

Preferably, the roof with the end running part is displaced and overruns a heap of a load protruding above the substructure during a closing process. The advantage is that the roof is configured to be sturdy enough at the front that it can move across a heap of a load so that it can be moved or run over. The aim is for the load to fill the loading space evenly in order to ensure a specific center of gravity of the load in the substructure so that load securing is reliable and safe. Furthermore, the loading space of the substructure is optimally used for the transportation of the load.

According to a further preferred embodiment, a preferably mechanical indicator signals a completely closed position of the structure. For a user, this has the advantage that the user can immediately recognize when the structure is completely closed and the vehicle or substructure is ready to drive. The mechanical indicator thus signals that the vehicle is ready to drive in such a way that a user can immediately take note of this without losing any time and can start transporting the load.

Conveniently, the structure is raised and/or lowered simultaneously with an opening operation of the roof or a closing operation of the roof. One advantage is the time savings, because vertical displacement of the structure and displacement of the roof can take place simultaneously. A further advantage is that it is possible to design a ramp-like travel path with the roof, so that the structure can be individually adapted to a pile of a load.

According to an expedient embodiment, at least one side wall which extends upward from a loading surface of the loading space is inclined in a direction toward the loading surface. The advantage is that the load can also be compressed via the side wall. The load can also be compacted and tensioned laterally. This leads to an even higher degree of compression, which further represses voids in the load and also improves lateral load securing. It should be noted that this can increase the force transmission to the structure to such an extent that it can no longer be lowered, so that no additional compression via the side wall is preferred.

Particularly preferably, in the above methods the structure is configured as described above.

Further advantages, properties, features and developments of the present disclosure emerge from the following description of a preferred embodiment and from the dependent claims.

### BRIEF SUMMARY OF THE DRAWINGS

The present disclosure is explained in more detail below with reference to the accompanying drawings.

FIG. 1 shows a perspective view of a preferred embodiment of a partially raised structure for a substructure with the roof closed and indicated tarpaulin.

FIG. 2 shows the structure from FIG. 1 without tarpaulin.

FIG. 3 shows the structure from FIGS. 1 and 2 in a partially raised position with the roof open.

FIG. 4 shows the structure from FIGS. 1 to 3 in a fully raised position with the roof closed.

FIG. 5 shows the structure from FIGS. 1 to 4 in a fully lowered position with the roof closed.

FIG. 6 shows a perspective view of a second embodiment of a fully lowered structure for a substructure with the roof closed.

FIG. 7 shows the structure from FIG. 6 in a fully raised position with the roof closed.

FIG. 8 shows the structure from FIGS. 6 and 7 in a fully raised position with the roof open.

FIG. 9 shows the structure from FIGS. 6 to 8 in a fully raised position with the roof open.

FIG. 10 shows the structure from FIGS. 6 to 9 in an inclined position with the roof closed.

FIG. 11 shows the structure from FIGS. 6 to 10 in a fully raised position with the roof open.

FIG. 12 shows a variant of the structure from FIGS. 6 to 11 in a fully raised position with the roof closed.

FIG. 13 shows the structure of FIG. 12 in an inclined position with the roof closed.

FIG. 14 shows the structure of FIGS. 12 and 13 in a fully raised position with the roof open.

FIG. 15 shows a variant of the structure from FIGS. 12 to 14 in a fully raised position with the roof closed.

FIG. 16 shows a variant of the structure from FIG. 15 in a fully raised position with the roof closed.

FIG. 17 shows the structure of FIG. 16 in a fully raised position with the roof open.

FIG. 18 shows the structure of FIGS. 16 and 17 in a fully raised position with the roof open and an eccentric lever device.

FIG. 19 is a perspective view of a third embodiment of a fully raised structure for a substructure with the roof closed.

FIG. 20 shows the structure from FIG. 19 in a fully raised position with the roof open.

FIG. 21 shows a variant of the structure from FIGS. 19 and 20 in a fully raised position with the roof closed.

FIG. 22 shows the structure from FIG. 21 in a fully raised position with the roof open.

FIG. 23 shows a perspective view of a fourth embodiment of a fully raised structure for a substructure with the roof closed.

FIG. 24 shows the structure from FIG. 23 in an open position.

FIG. 25 shows a schematic front view of an bow.

FIG. 26 shows a perspective schematic view of an arrangement of roof elements of a structure for a substructure with closed and with open roof.

FIG. 27 shows the structure from FIG. 26 in a schematic side view.

FIG. 28 shows a variant of the structure from FIGS. 1 to 5 in a lowered position with the roof open.

FIG. 29 shows a rear view of a combination of the structure from FIG. 1 and FIG. 16 in a fully raised position with the roof closed.

### DETAILED DESCRIPTION

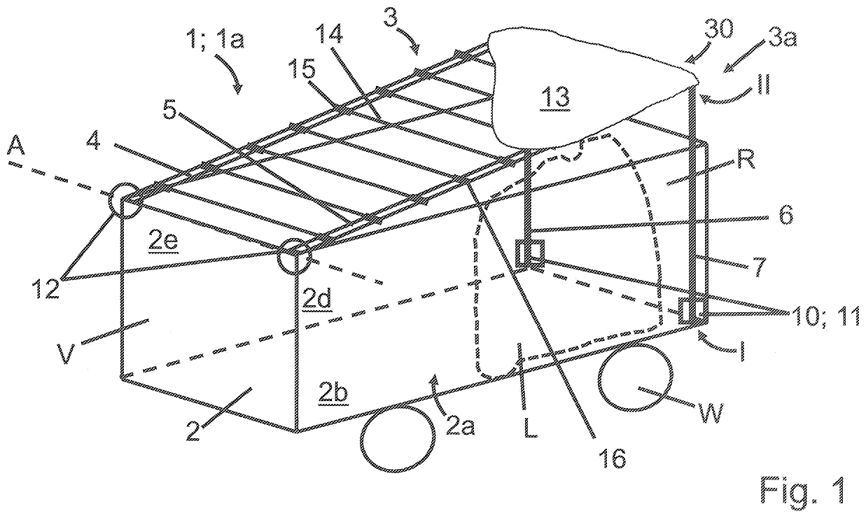

FIG. 1 is a perspective view of a first embodiment of a structure 1 with a body 1a for a substructure 2 or a trailer 2, which has wheels W for movement.

The trailer 2 comprises a front wall V and an opposite rear wall R. The trailer 2 has a loading surface 2b, which is delimited in the longitudinal direction by a side wall 2d; 2e. Thus, a loading space 2a of the trailer 2 is defined by the front wall V, the rear wall R, the loading surface 2b and the two side walls 2d; 2e. The side walls 2d; 2e, the front wall V and the rear wall R enclose an opening 3a which is open at the top and through which the loading space 2a can be filled with a load L.

Above the trailer 2 there is a vertically displaceable structure 1 which comprises a first longitudinal beam 4 and a second longitudinal beam 5. The first longitudinal beam 4 and the second longitudinal beam 5 are each connected in an articulated manner in a region of the front wall V at the top in a particular corner region of the trailer 2 via a slot-pin combination configured as coupling kinematics 12.

In a region of the opposite rear wall R of the trailer 2, the first longitudinal beam 4 is articulated to a first vertically displaceable stanchion 6 in a stanchion upper part II and the second longitudinal beam 5 is articulated to a second vertically displaceable stanchion 7 in a stanchion upper part II. Here, the first stanchion 6 and the second stanchion 7 each have a connection in a stanchion lower part I with the loading surface 2b of the trailer 2, so that the first stanchion 6 and the second stanchion 7 are always arranged in a vertical position. Furthermore, each stanchion 6, 7 contains its own lifting drive 10 or stanchion drive 11, whereby the structure 1 can be raised or lowered. The stanchion drive 11, which is only indicated schematically, is configured, for example, as an electrically telescopic spindle-rod/spindle-nut unit which forms a linear drive.

Arranged between the two vertically displaceable longitudinal beams 4, 5 is a foldable, openable roof 3 which can be displaced in the longitudinal direction of the longitudinal beams 4, 5 in order to open the area between the two longitudinal beams 4, 5 which, when the structure 1 is lowered, corresponds to the opening 3a which is open at the top. The roof 3 comprises a continuous tarpaulin 13 which is connected to bows 14 that can be displaced along the longitudinal beams 4, 5. The bows 14 each have at least one support roller and one guide roller for easier displacement along guide tracks of the longitudinal beams 4, 5. If the bows 14 are pushed together into an end region of the longitudinal beams 4, 5, the tarpaulin 13 folds and the upper opening 3a is largely uncovered. Furthermore, a lowerable end running part 30 is pivotally connected to the foremost bow 14 in the closing direction of the roof 3, which tightens the tarpaulin 13 when lowered and also surrounds and stiffens the longitudinal beams 4, 5. Furthermore, the bows 14 can be displaced in the longitudinal direction of the two longitudinal beams 4, 5 with the aid of sliding carriages 15; 16.

In a region of the rear wall R of the trailer 2, a foldable tarpaulin 13 is indicated which is connected to the movable bows 14 and protects a load L from rain and other weather influences.

The structure 1 is raised in a region of the rear wall R by the first stanchion 6 and the second stanchion 7, so that a first pivot axis A of the structure 1 is formed on the opposite front wall V.

An alternative design variant with respect to the structure 1 shown in FIG. 1 provides that the two stanchions 6; 7 are arranged in a region of the front wall V, and that the first longitudinal beam 4 and the second longitudinal beam 5 are each connected in an articulated manner in a region of the rear wall R at the top in a particular corner region of the trailer 2 via a slot-pin combination configured as coupling kinematics 12. In this respect, the structure 1 can be raised or lowered in the region of the front wall V.

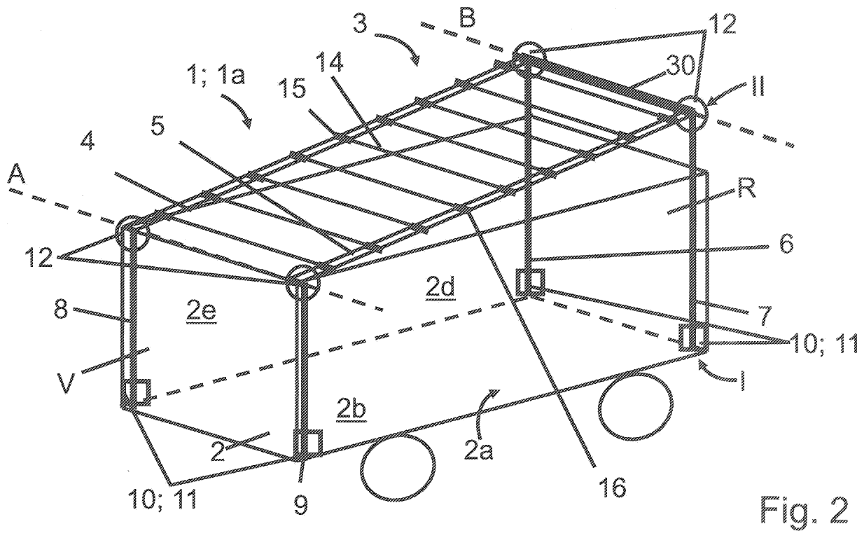

FIG. 2 shows, corresponding to FIG. 1, the same structure 1 with a body la for a substructure 2, wherein the first longitudinal beam 4 and the second longitudinal beam 5 now being connected in an articulated manner at the front in a region of the front wall V to a third stanchion 8 and to a fourth stanchion 9 by means of a stanchion upper part II. As a result, the substructure 2 has a total of four stanchions 6, 7, 8 and 9, each of which is located in the corners of the substructure 2, and which are all arranged by means of a stanchion lower part I in the region of the loading surface 2b and preferably outside the loading space 2a. All stanchions 6, 7, 8 and 9 have the same structure and each comprise its own lifting drive 10 or stanchion drive 11, whereby the structure 1 can be displaced vertically. Thus, the first longitudinal beam 4 and the second longitudinal beam 5 can be displaced vertically via the stanchions 6, 7, 8 and 9. In this respect, the structure 1 has a second pivot axis B, which is formed in the region of the rear wall R of the substructure 2.

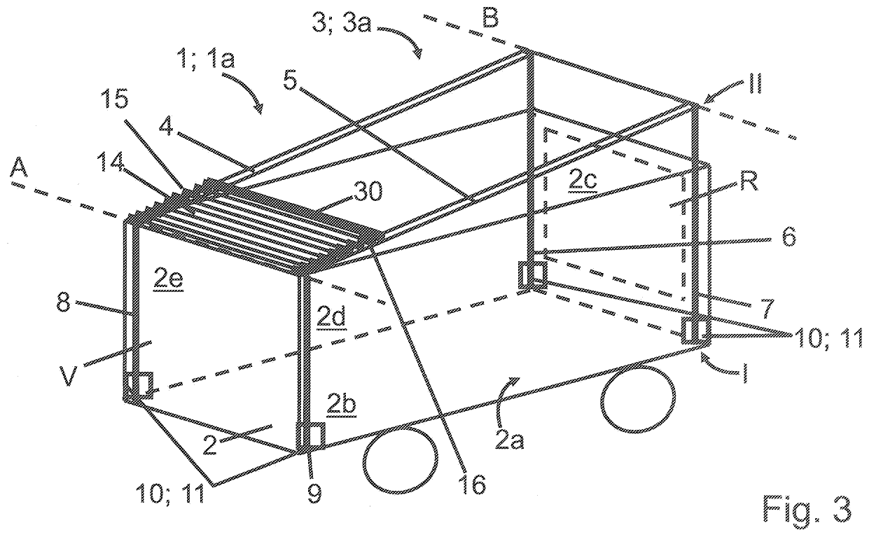

FIG. 3 shows, corresponding to FIG. 2, a structure 1 for a substructure 2 with an opened roof 3, whereby a roof opening 3a is exposed. For this purpose, bows 14 with the tarpaulin 13 from FIG. 1, which is not shown for reasons of clarity, are displaced along the two longitudinal beams 4, 5 in a direction toward the front wall V of the substructure 2. Of course, the bows 14 can also be completely displaced in one direction toward the rear wall R of the substructure 2 in order to expose the upper roof opening 3a.

Furthermore, in FIG. 3, a flap 2c is shown in dashed lines in the rear wall R, which can be used to unload the substructure 2. The flap 2c is pivotably connected to the rear wall R, but it is possible to design the entire rear wall R as a pivotable and openable flap.

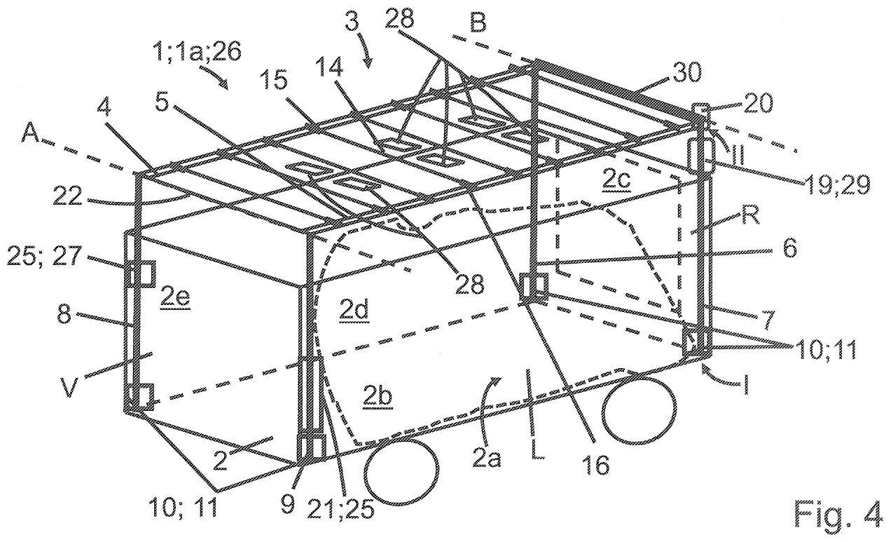

FIG. 4 shows a structure 1 with a body 1a for a substructure 2 in which the roof 3 is completely closed and in which the first longitudinal beam 4 and the second longitudinal beam 5 are raised to a maximum above the four stanchions 6, 7, 8 and 9, so that the structure 1 is arranged above the substructure 2 in a horizontal plane 26. A cross member 22, which is located transversely between the two longitudinal beams 4; 5, serves for parallel alignment and for stiffening the two longitudinal beams 4; 5.

In FIG. 4, multiple load sensors 28 are arranged centrally between the longitudinal beams 4, 5 on the tarpaulin 13 or on one of the bows 14, which are configured, for example, as pressure sensors or as strain gauges. The load sensors 28 detect a pressure or a force which—usually originating from the load L—is exerted on the structure 1 and in particular on its sliding roof 3, so that the detected measured value can be transmitted to a controller 27 in which a threshold value for a maximum load on the roof 3 in the vertical direction is stored. When the threshold value is reached or exceeded, the controller 27 causes an end to the lowering of the structure 1 and preferably an at least slight raising of the structure 1. It is also possible to reliably detect any blockages caused by obstacles. The load sensor 28 can alternatively also be arranged in the region of the substructure 2.

Furthermore, the stanchion drive 11 contains an overload protection 19, which is configured as a slip clutch, so that damage to the lifting drive 10 or to the stanchion drive 11 is prevented. If, for example, the substructure 2 is filled with a non-compressible load L, e.g., hard coal, the structure 1 cannot be completely lowered without damage to the structure 1 occurring. Therefore, the overload protection 19 decouples the lifting drive 10 or the stanchion drive 11 from a specific force or from a specific torque so that it spins, thereby avoiding costly damage to the lifting drive 10 or the stanchion drive 11.

In FIG. 4, the reference sign 20 designates one of the distance sensors which is arranged in the corner region of the substructure 2 and which detects a measured value for the distance of the structure 1 to the substructure 2 in the region of the stanchions 6, 7, 8, 9. The measured value is transmitted to a controller 27 in order to determine, on the one hand, whether the maximum permissible travel height has been reached or exceeded and, on the other hand, to regulate the speed at which the structure 1 is displaced in the direction of the substructure 2.

In FIG. 4, the reference sign 29 designates a closing sensor which is arranged in the corner region of the structure 1 and which detects a measured value for the distance of the (open) roof 3 to a corner region of the structure 1. It is also possible to design the closing sensor 29 as a contact sensor or limit switch which detects the presence of the end running part 30 in the lowered closing position 31. The measured value is sent to a controller 27 to determine whether the roof 3 is closed and thus a state has been reached in which participation in road traffic is permitted.

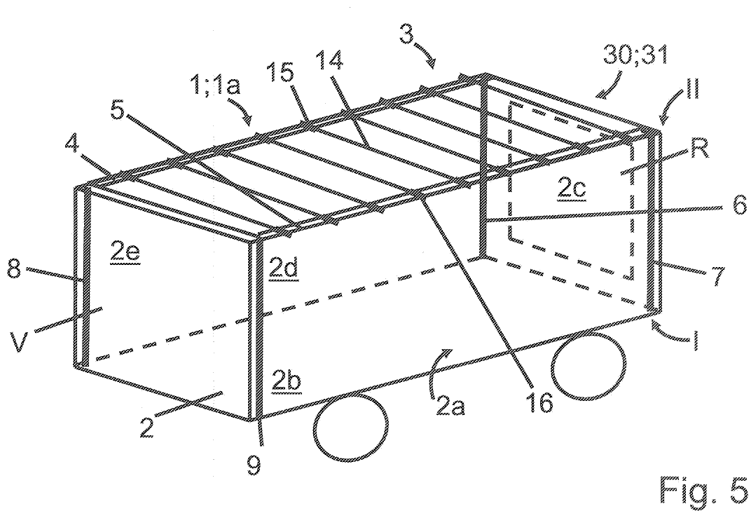

Conveniently, when the closing sensor 29 and the distance sensor 20 each indicate that the roof 3 is completely closed and that the structure 1 is completely lowered as shown in FIG. 5, an indicator, for example an LED, can be activated or deactivated to indicate to a driver that the vehicle is ready to drive.

Furthermore, the lifting drive 10 or the stanchion drive 11 of the structure 1 can preferably be locked by means of a locking assembly 21 via a displaceable latch 25 as soon as the vehicle is ready to drive. The readiness to drive is characterized by the fact that the structure 1 has a completely closed position 31, as shown in FIG. 5. After lowering the structure 1 to a certain height of the structure 1, the control 27 sends a signal to the locking assembly 21, whereby the lifting drive 10 or the stanchion drive 11 is switched off and locked via the latch. Thus, the structure 1 cannot be displaced accidentally and/or in an undesirable situation, e.g., in the event of strong wind or a change in the external pressure conditions, which occur, for example, when entering a tunnel.

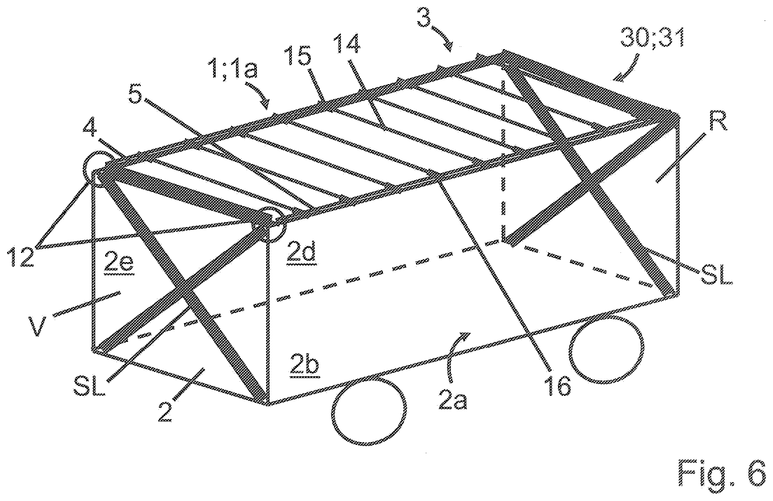

FIG. 6 is a perspective view of a second embodiment of a structure 1 with a body la for a substructure 2 or a trailer 2 according to FIG. 1, the two longitudinal beams 4; 5 now being driven via scissor kinematics SL so as to be vertically displaceable in height relative to the substructure 2. The structure 1 is shown in FIG. 6 in a fully closed position 31.

The scissor kinematics SL are arranged at one end in a region of the front wall V and the other end in a region of the rear wall R. The two longitudinal beams 4; 5 are connected in an articulated manner to the relevant scissor kinematics SL, which are configured as a lifting scissor, via coupling kinematics 12.

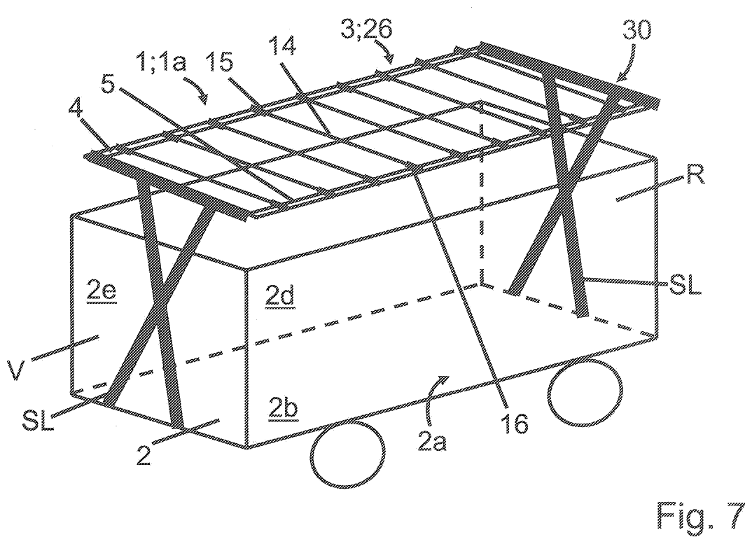

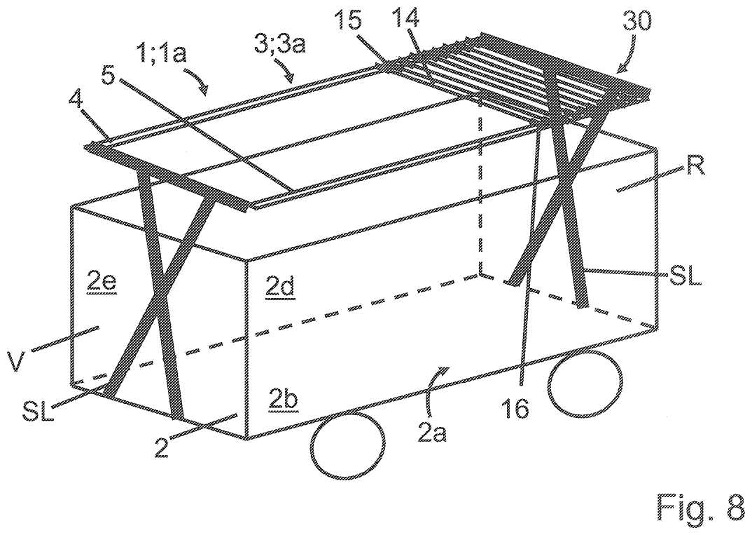

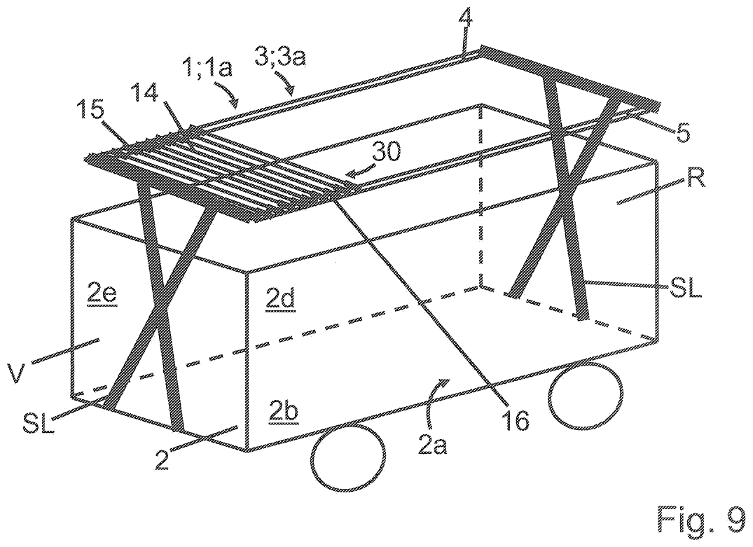

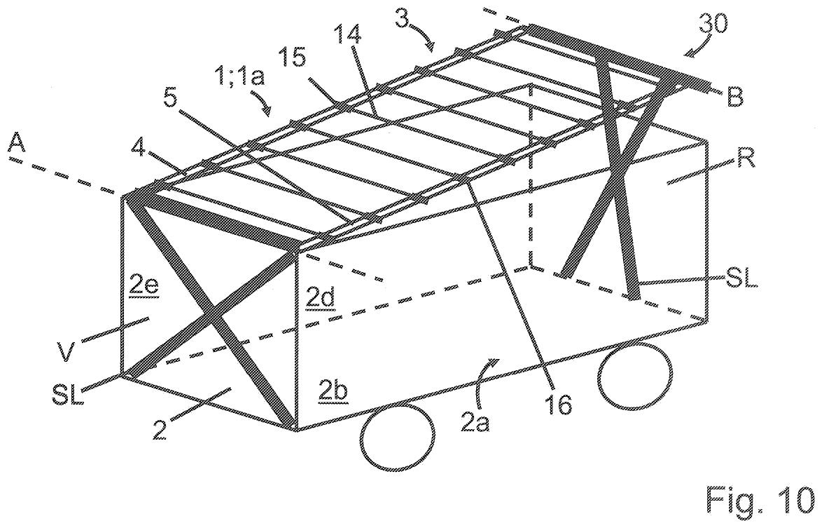

FIG. 7 to FIG. 10 show a structure 1 raised via the scissor kinematics SL according to FIG. 6, the roof 3 being shown in an open position 3a in FIG. 8 and FIG. 9 and the structure 1 and the roof 3 being shown in an inclined position in FIG. 10.

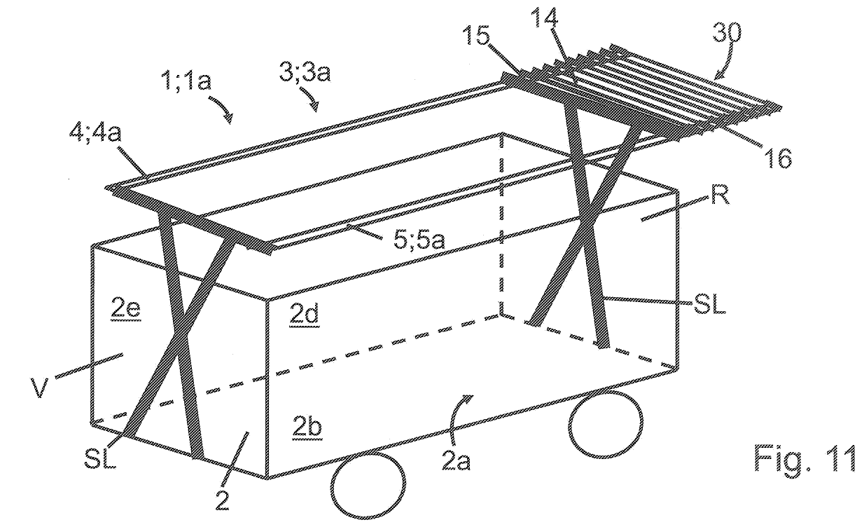

In order to completely open the substructure 2, it is possible to displace the roof 3 by means of extendable longitudinal beams 4a; 5a in a region outside the substructure 2, as shown in FIG. 11. The two longitudinal beams 4; 5 have telescopic elements 4a; 5a, whereby the folded roof 3 can be arranged completely outside the substructure 2. The roof 3 is thus positioned behind the rear wall R above the substructure 2 in order to ensure the largest possible opening 3a for filling the substructure 2. It is understood that the roof 3 can also be arranged in this way in a region of the front wall V, because the two longitudinal beams 4; 5 have telescopic extension rails 4a; 5a on both of their end faces.

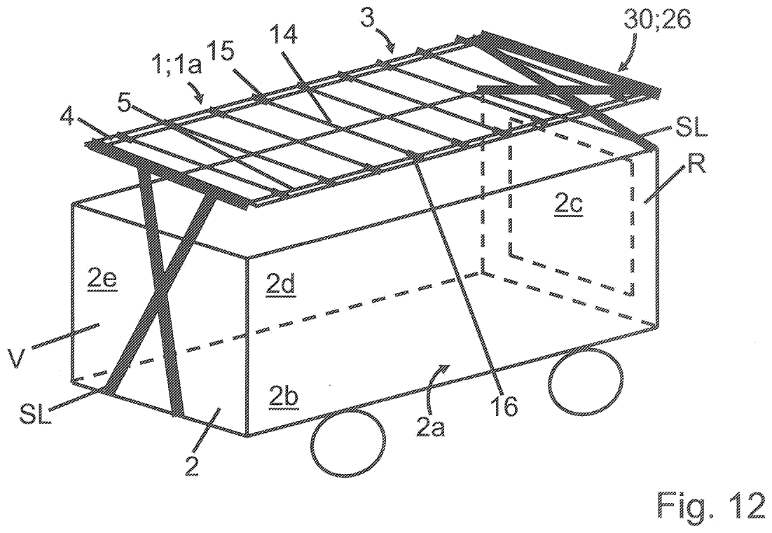

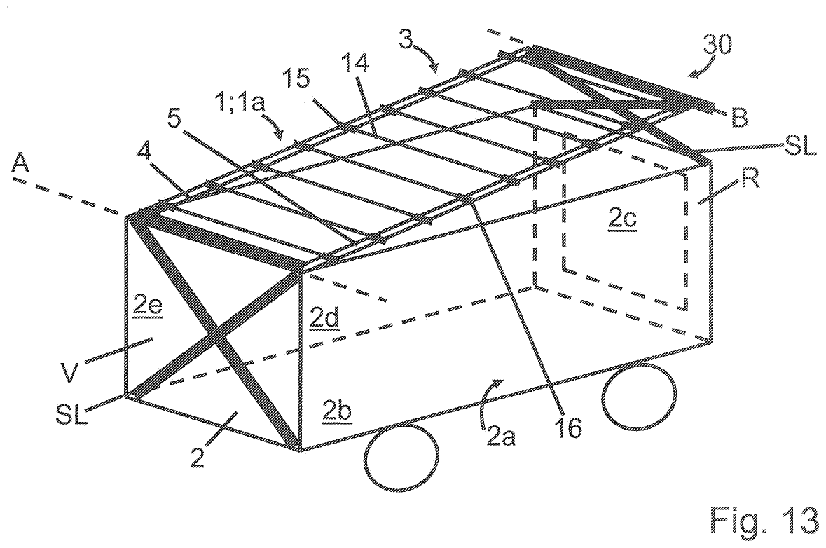

In order to allow unloading of the substructure 2 via a flap 2c arranged in the rear wall R, FIG. 12 shows scissor kinematics SL which are located outside the flap 2c. Thus, the flap 2c can be opened and closed without obstructions, which allows free access to the loading space 2a of the substructure 2 when the flap 2c is open. It is understood that the rear wall R can also be configured as a pivoting flap or at least a door which can provide access to the loading space 2a of the substructure 2. The shortened scissor kinematics SL from FIG. 12, which are arranged in a region above the rear wall, is configured in its function for raising and lowering the structure 1 according to the scissor kinematics SL from FIG. 6. In FIG. 12 and FIG. 13, the structure 1 is shown in a horizontal position 26 raised via the scissor kinematics SL and in an inclined position with the roof 3 closed. The structure 1 is tilted via the two pivot axes A; B, as shown in FIG. 13.

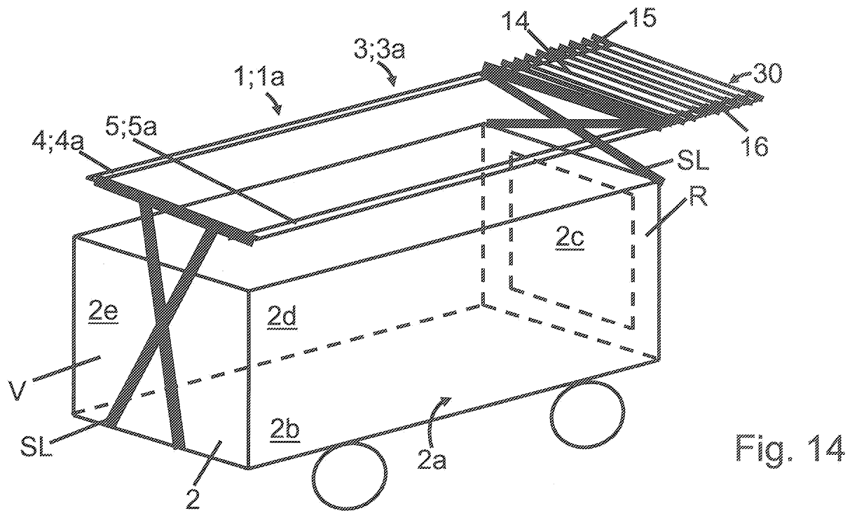

According to FIG. 11, in FIG. 14 the two longitudinal beams 4; 5 have telescopic pull-out rails 4a; 5a, whereby the folded roof 3 can be displaced into a region outside the substructure 2. In this respect, it is possible to create a combination of scissor kinematics SL for lifting the structure 1 and telescopic longitudinal beams 4; 5. As a result, the largest possible opening 3a of the roof 3 for the substructure 2 is exposed and the flap 2c is displaced for unloading.

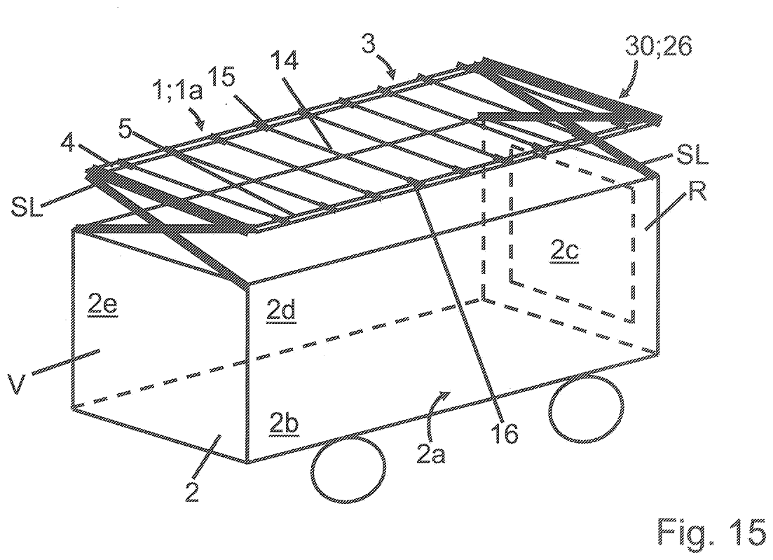

Shortened scissor kinematics SL can be arranged on both sides, namely in a region above the front wall V and in a region above the rear wall R of the substructure 2, resulting in a compact and space-saving design of the substructure 2 and the drive for the structure 1. This arrangement with regard to the shortened scissor kinematics SL on both sides is shown in FIG. 15. It is possible, for example, to integrate a further flap into the front wall.

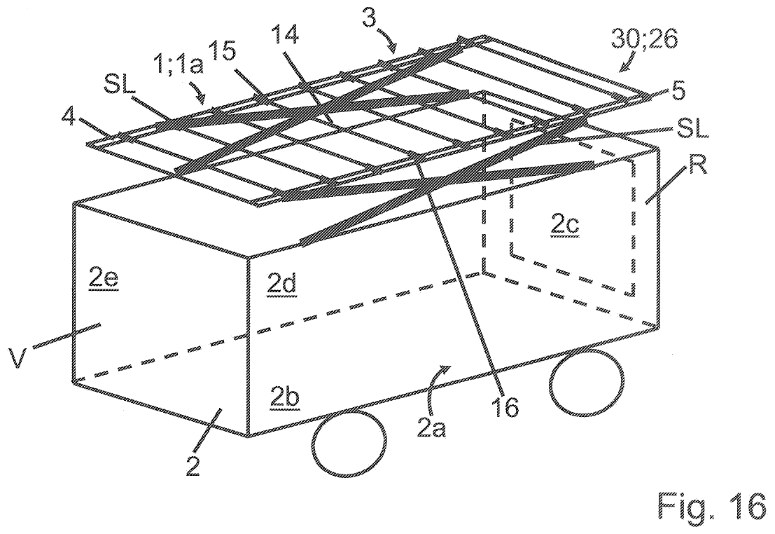

FIG. 16 shows an alternative arrangement of the shortened scissor kinematics SL according to FIG. 15. Here, in the longitudinal direction of the substructure 2, both scissor kinematics SL are located above the relevant side wall 2d; 2e, thereby achieving increased stability of the structure 1.

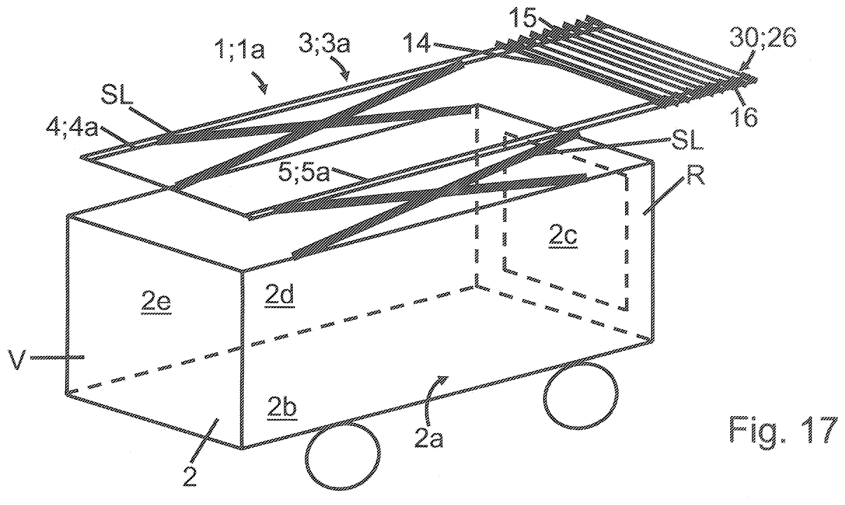

Corresponding to FIG. 11 and FIG. 14, FIG. 17 also shows a structure 1 which has telescopic longitudinal beams 4a; 5a, whereby the folded roof 3 can be arranged outside the opening 3a of the substructure. In this respect, on the one hand, the structure 1 is configured to be stable and sturdy by means of the side wall scissor kinematics SL and, in addition, the possibility is provided of moving the roof 3 completely outside the substructure 2, so that loading from above can be carried out as much as possible without any disturbing elements, e.g., bows.

It is understood that the telescopic or extendable longitudinal beams 4a; 5a can be integrated for raising and lowering regardless of the type of drive of the structure 1. As a result, it is possible to use the telescopic or extendable longitudinal beams 4a; 5a with stanchions 6; 7; 8; 9 as well as with scissor kinematics SL and combinations of the aforementioned.

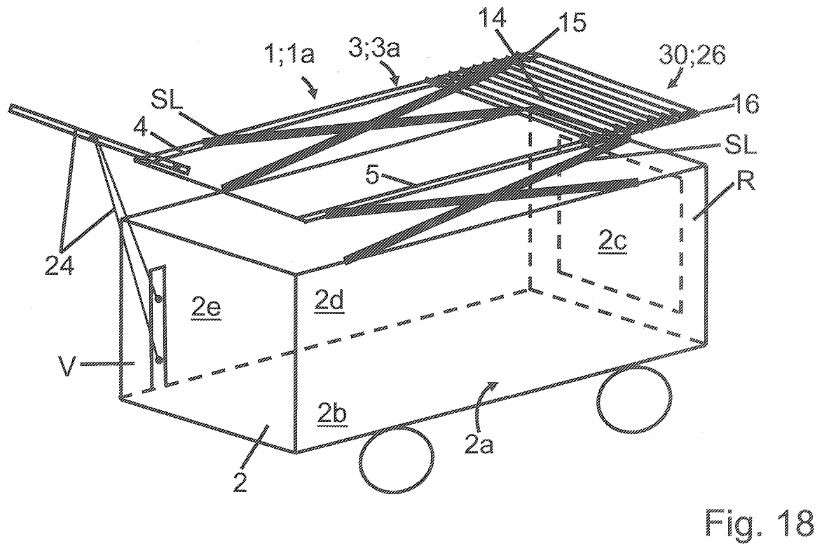

Corresponding to the FIG. 16 above, FIG. 18 shows an alternative embodiment of a structure 1 for a substructure 2 with an eccentric lever device 24, which serves for lowering and locking the structure 1. The eccentric lever device 24 comprises toggle-lever-joint kinematics, whereby the structure 1 can be manually displaced downward. In this case, high low-tension forces can be permanently applied to a load L.

Furthermore, the eccentric lever device 24 comprises an integrated locking mechanism, whereby the lowered structure 1 can be brought into a position ready for driving. The eccentric lever device 24 is preferably arranged in the four corners of the substructure 2 in order to ensure a uniform and complete lowering of the structure 1 in the direction of the substructure 2.

It is understood that the eccentric lever device 24 can be integrated into a substructure 2 in the body 1a, regardless of the type of drive of the structure 1.

The eccentric lever device 24 can also serve as an independent lifting/lowering device and/or as an independent locking device for the structure 1 for compressing a load L.

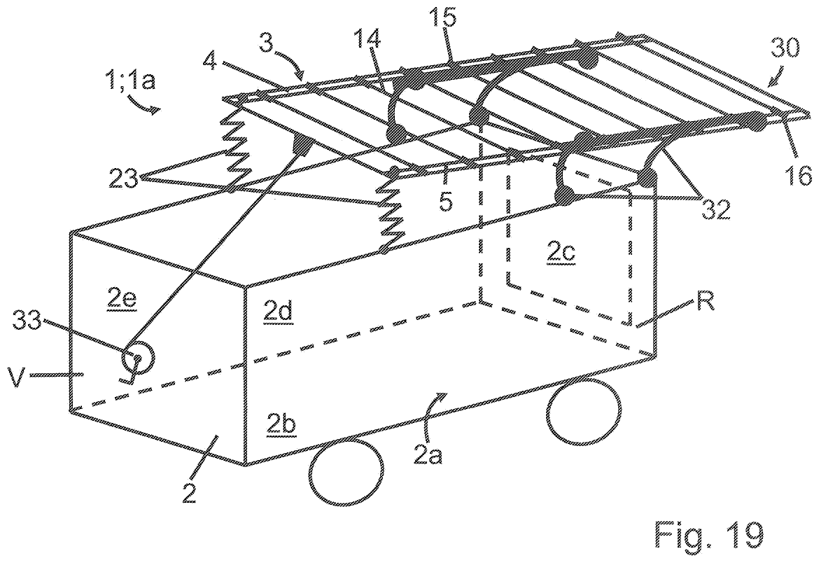

FIG. 19 shows a perspective view of a third embodiment of a raised structure 1 with a body 1a for a substructure 2 or a trailer 2. The substructure 2 from FIG. 19 substantially corresponds to the substructure 2 from the preceding embodiments. The structure 1 comprises a first longitudinal beam 4 and a second longitudinal beam 5, which are aligned parallel to one another. Furthermore, the longitudinal beams 4; 5 are arranged above the substructure 2 in its longitudinal direction. Transversely to the longitudinal beams 4; 5, movable bows 14 are connected to the longitudinal beams 4; 5. By means of sliding carriages 15; 16, which are arranged at the ends of the bows 14, the bows 14 can be displaced along the two longitudinal beams 4; 5 in a direction toward the front wall V or in a direction toward the rear wall R of the substructure 2. Furthermore, a foldable tarpaulin 13, which is not shown for reasons of clarity, is connected to the bows 14.

In order to be able to displace the structure 1 in a direction away from the substructure 2, the structure 1 has multi-joint kinematics configured as a four-joint arrangement 32. In this third embodiment, the four-joint arrangement 32 is connected in an articulated manner at one end to the substructure 2 at its side walls 2d; 2e, and at the other end the four-joint arrangement 32 is connected in an articulated manner to the two longitudinal beams 4; 5. Furthermore, the structure 1 comprises at least one spring device 23, each longitudinal beam 4; 5 having at least one tension spring which is connected to the substructure 2.

The end running part 30 and the opposite bow 14 have a traction cable device 33 with a crank. For reasons of clarity, only one traction cable device 33 is shown in a region of the front wall V of the substructure 2. By means of the traction cable device 33, it is possible to manually displace the structure 1 either in a direction toward the rear wall R of the substructure 2 for raising the structure 1 or in a direction toward the front wall V of the substructure 2 for lowering the structure 1.

The four-joint arrangement 32 specifies a defined displacement path of the structure 1, both when raising and when lowering the structure 1. The spring device 23 supports a displacement of the structure 1 with its tension springs, so that lowering the structure 1 and thus compressing a load L is effortless for a user. Furthermore, the spring device 23 supports the lifting of the structure 1 in that the spring device 23 brakes the structure 1 and thus provides a type of soft-close device. As a result, when lifting, structure 1 is slowed down shortly before reaching an end position and brought into the end position with little noise. Accordingly, this can also be intended for lowering the structure 1.

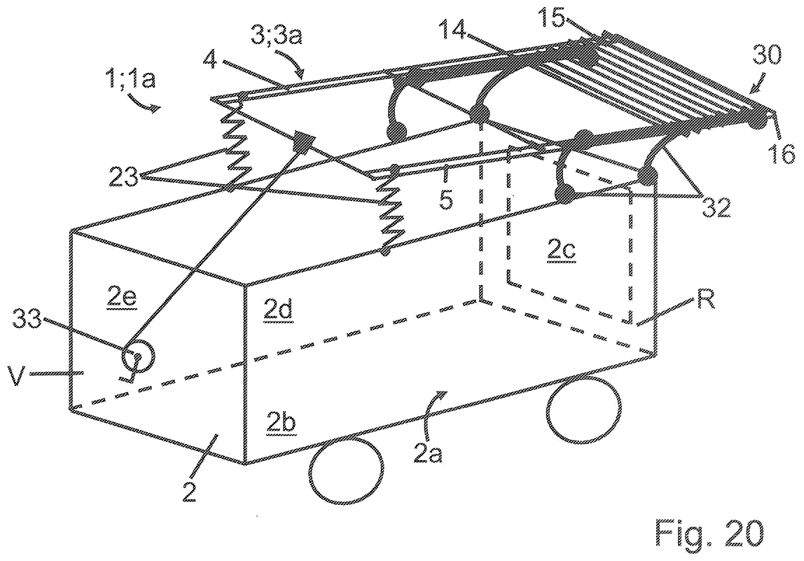

FIG. 20 shows the structure 1 from FIG. 19 for a substructure 2 in a raised position, the roof 3 being folded together and thus exposing an opening 3a so that the substructure 2 can be loaded with a load L from above. A special feature is that the folded roof 3 is located outside the substructure 2, which allows the largest possible opening 3a of the substructure 2 to be exposed for loading with a load L. Advantageously, no extendable longitudinal beams 4a; 5a are required to arrange the folded roof 3 outside the substructure 2.

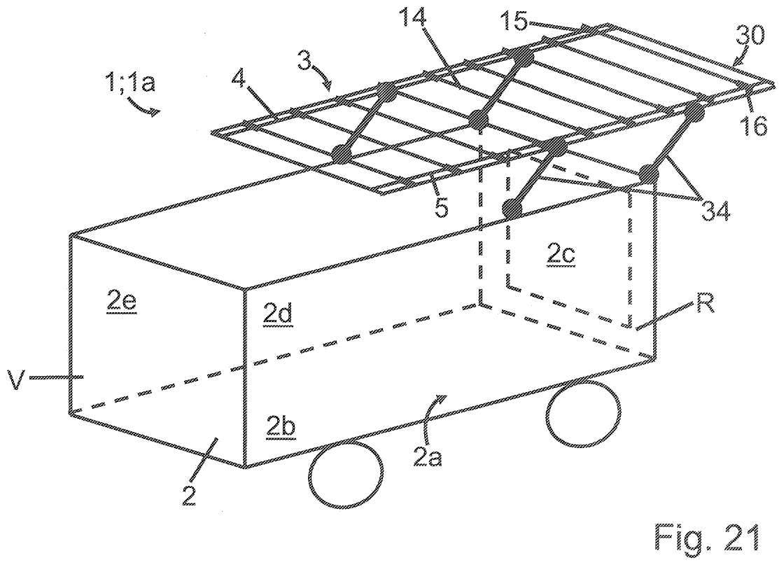

In FIG. 21, corresponding to FIG. 19, an alternative embodiment is shown with regard to the multi-joint kinematics of the structure 1. The multi-joint kinematics comprise multiple links 34, which are articulated at one end to the substructure 2 in a region of the side walls 2d; 2e and at the other end to the relevant longitudinal beam 4; 5. The links 34 have parallelogram linkage kinematics 34, whereby the structure 1 has a defined displacement path when raised or lowered. According to FIG. 19, a spring device 23 and a traction cable device 33 can also be used in the embodiment shown in FIG. 21.

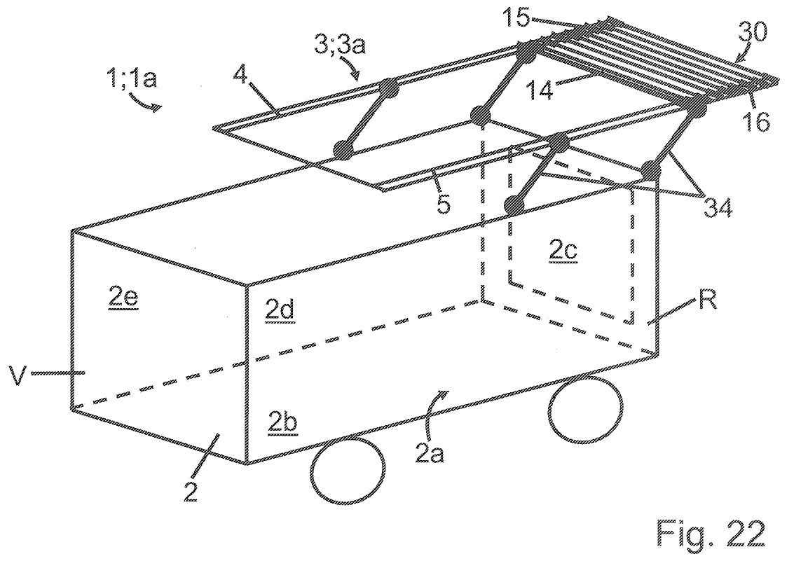

FIG. 22 shows the structure 1 from FIG. 21 in a horizontal position, with the folded roof 3 being located outside the substructure 2, thereby exposing the largest possible opening 3a of the substructure 2 for loading from above with a load L.

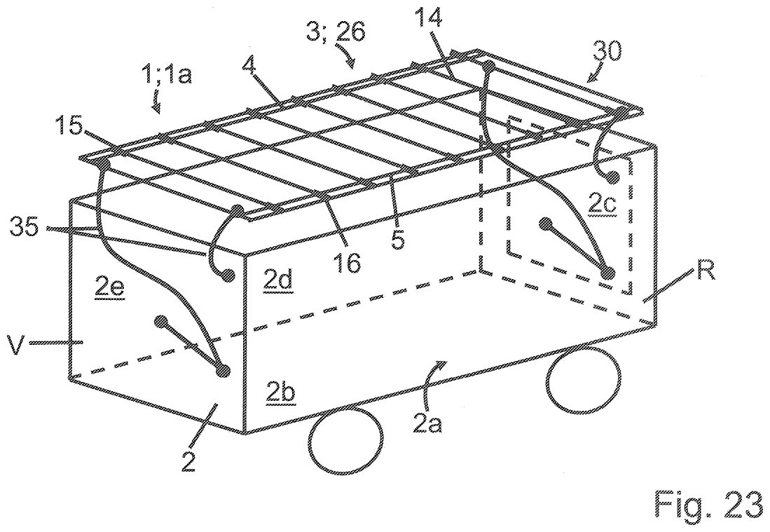

A fourth embodiment of a structure 1 with a body la for a substructure 2 or a trailer 2 is shown in FIG. 23 in a perspective view. The substructure 2 substantially corresponds to the above embodiments. The structure 1 substantially comprises an embodiment which is shown, inter alia, in FIG. 19 and has been described above. In FIG. 23, the structure 1 is shown in a raised and horizontal position relative to the substructure 2. The structure 1 has multi-joint-side kinematics 35, which are articulated at one end in a region of the front wall V and in a region of the rear wall R of the substructure. At the other end, the multi-joint-side kinematics 35 are connected in an articulated manner to the longitudinal beams 4; 5 at each end, whereby the structure 1 is connected to the substructure 2 in a displaceable manner.

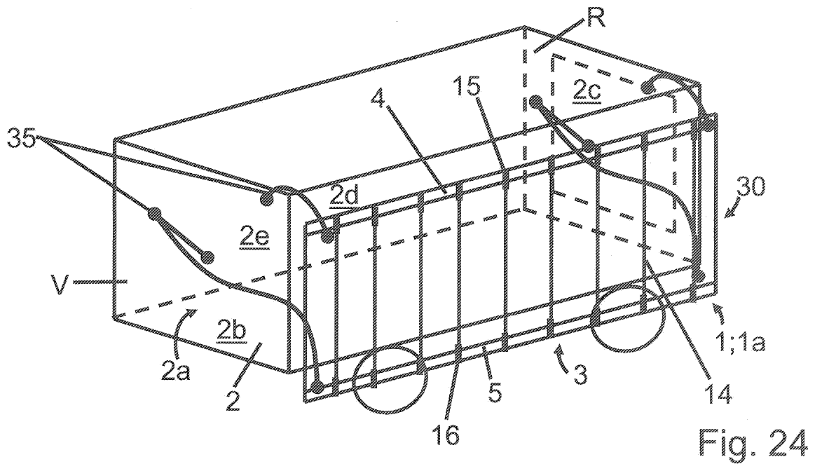

FIG. 24 shows the fourth embodiment from FIG. 23, the structure 1 being first raised relative to the substructure 2 via the multi-joint-side kinematics 35 and being folded downward approximately 90° so that the side wall 2d and the structure 1 are arranged substantially parallel to one another. As a result, an upper opening of the substructure 2 is completely exposed so that no disturbing elements hinder the loading of the substructure 2 with a load L. The multi-joint-side kinematics 35 can be operated manually for moving the structure 1, for example via a traction cable device 33, or can be operated automatically via a lifting drive 10.

Regardless of the type of drive used to raise or lower the structure 1, certain forces act on the longitudinal beams 4; 5 and on the bows 14, which require tolerance compensation so that the structure 1 can be tilted, raised and lowered accordingly.

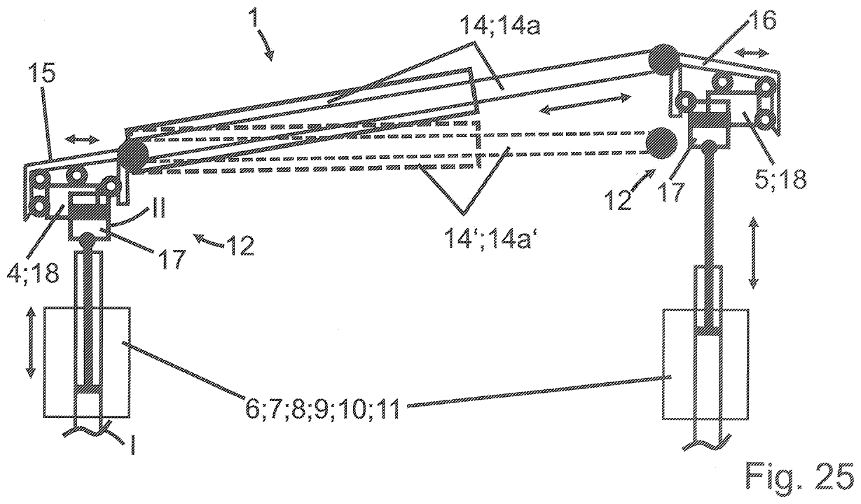

In FIG. 25, the structure 1 is shown schematically in a front view. By way of example, two stanchions 6; 7; 8; 9, each with a lifting drive 10 or stanchion drive 11, are shown schematically as a drive. The stanchions 6; 7; 8; 9 have a stanchion lower part I and a stanchion upper part II. The relevant stanchion lower part I is connected to the substructure 2, the substructure 2 not being shown in FIG. 25 for reasons of clarity.

The particular stanchion upper part II is connected to one of the two longitudinal beams 4; 5 via coupling kinematics 12. Furthermore, each longitudinal beam 4; 5 comprises a longitudinal beam base part 17 and a longitudinal beam guide part 18. The longitudinal beam base part 17 is connected directly to the relevant stanchion drive 11; furthermore, the longitudinal beam base part 17 contains a pin arranged transversely to the longitudinal beams 4; 5, to which the longitudinal beam guide part 18 is displaceably connected via a corresponding eye. As a result, both longitudinal beams 4; 5 can be displaced in the transverse direction, for example to compensate for a change in length.

Furthermore, both longitudinal beams 4; 5 have bows 14; 14a that can be displaced via sliding carriages 15; 16. The carriages comprise rollers which roll or slide in the guide tracks of the longitudinal beams 4; 5 and can thus fold the roof 3, among other things, thereby exposing a roof opening 3a for loading the substructure 2. If the structure 1 is displaced, e.g., if the substructure 2 is inclined in the longitudinal direction, a tensile force acts on the bows 14; 14a in portions, which force is compensated by a change in the length of the bows 14; 14a via a telescopic bow shaft 14a. The bows 14; 14a can thus be dynamically changed in their length by means of an extendable or telescopic element, which advantageously results in tolerance compensation when the structure 1 is displaced, whereby the structure 1 can be displaced smoothly and quietly.

Furthermore, in FIG. 25, an bow 14′ or an extendable bow 14a′ is shown in dashed lines in an initial position which the bow 14′; 14a′ assumes in a horizontal arrangement in a horizontal plane 26 of the structure 1.

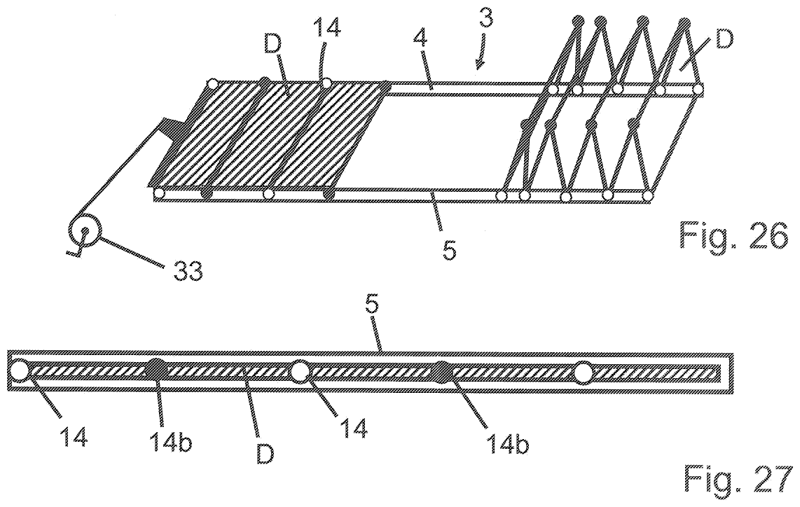

Instead of a tarpaulin 13 or a net panel, roof elements D can be arranged between the bows 14 with respect to the openable roof 3, as shown in FIG. 26 and FIG. 27 and can be folded together like an accordion. The roof elements D are connected to the bows 14 in an articulated manner, whereby they cover the roof opening 3a when the roof 3 is closed, lying flat adjacent to one another in one plane. Due to the higher rigidity of the roof elements D compared to a tarpaulin 13, the roof elements D can exert a higher compressive force F on a load L within the substructure 2.

FIG. 26 shows a perspective schematic view of the openable roof 3 of the structure 1, the closed roof 3 with the roof elements D that can be arranged in one plane on the one hand being shown in portions, and on the other hand the folded open roof 3 with the partially raised roof elements D being shown. The roof elements D are usually displaced via rollers or sliding carriages which are connected to the bows 14 and which can be displaced along the two longitudinal beams 4; 5. On an end face of the structure 1, a traction cable device 33 connected to an bow 14 is shown with which a user can displace the roof 3 having the articulated roof elements D by pulling the traction cable device 33 and thus open or close the roof 3 depending on a pulling direction of the traction cable device 33.

FIG. 27 shows schematically a portion of a side view of the longitudinal beam 5 from FIG. 26. The roof elements D have alternating lifting beams 14b and bows 14. When the roof 3 is opened, the lifting beams 14b are displaced upward and the bows 14 remain connected below to the two longitudinal beams 4; 5.

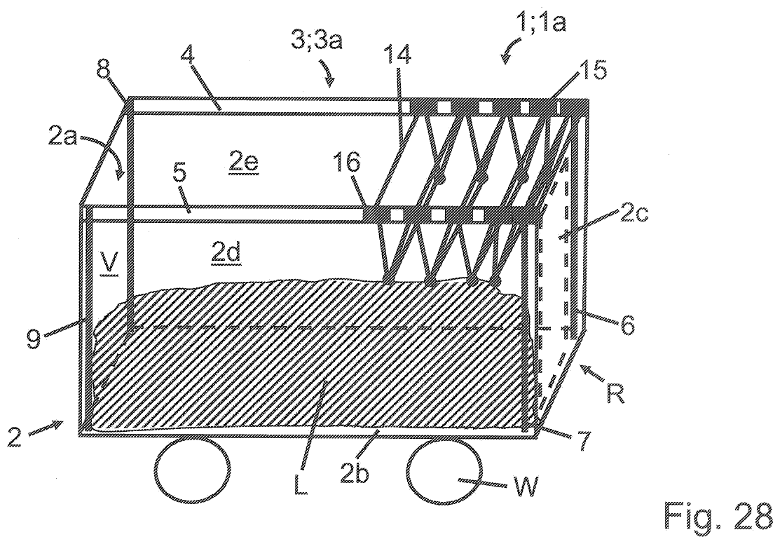

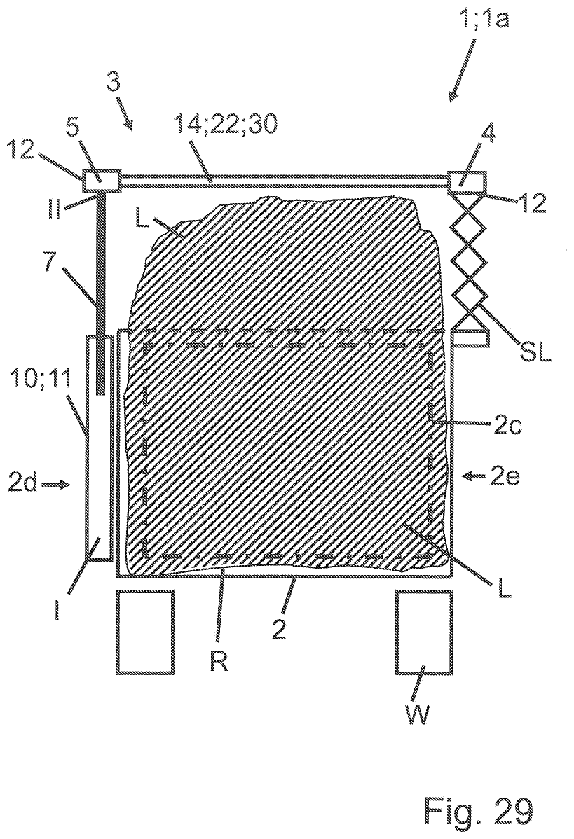

In FIG. 28, a liftable structure 1 having a body la for a substructure 2 according to FIG. 2 is shown. The difference, however, is that the foldable roof 3, in an opened state, exposes an opening 3a of the substructure 2 and comprises bows 14 pointing downward toward the loading surface 2b of the substructure 2. Advantageously, this alternative arrangement of the bows 14 provides an opportunity to compress the load L in the substructure 2 at an early stage of filling it with load L. The downwardly projecting bows 14 press on the load L from above, compressing it in the loading space 2a of the substructure 2. Furthermore, structure 1 can be manufactured in a space-saving and compact manner, which allows it to be used in a hall or in a barn with a low ceiling.

For the sake of clarity and comprehensibility, FIG. 29 shows schematically the raised structure 1 with the body la for a substructure 2 in a view from behind onto the rear wall R. The substructure 2 is supported on wheels W. The rear wall R with the flap 2c is arranged above the wheels W. The flap 2c is shown as a rectangle with a dashed line. An upper edge of the rear wall R is also shown as a dashed line, which defines the maximum height of the substructure 2. The load L, which is located inside the substructure 2, clearly protrudes beyond the rear wall R and thus the entire substructure 2.

In FIG. 29 it is thus clearly shown that the load L can be filled in protruding above the substructure 2, which illustrates the economic interest of compressing the load L and thus utilizing the entire loading space 2a of the substructure 2.

By way of example, the substructure 2 has on the left side wall 2d a stanchion 7 with a lifting drive 10 or with a stanchion drive 11. The stanchion 7 comprises a stanchion lower part I and a stanchion upper part II. The stanchion lower part I serves for connection to the substructure 2, and via the stanchion upper part II the stanchion 7 is connected to the longitudinal beam 5 by means of coupling kinematics 12. The right-hand side wall 2e of the substructure 2 comprises, by way of example, scissor kinematics SL, which are connected at their upper end to the longitudinal beam 4. Arranged between the two longitudinal beams are, among other things, bows 14, cross members 22 and an end running part 30, to which a tarpaulin 13 or a net panel can be connected.

To compress the load L, both longitudinal beams 4; 5 are displaced downward onto the substructure 2 via the stanchion drive 11 and the scissor kinematics SL until a specific height of the roof 3 or the structure 1 is reached which is sufficient for the substructure 2 to be ready to drive. The compression of the load L can also be carried out in multiple partial steps, so that the cavity portion of the load L is reduced as much as possible.

The present disclosure functions as follows:

First, the roof 3 of the structure 1 is opened to provide access or an opening 3a to the loading space 2a of the substructure 2. This is followed by filling from above with a load L, which has a low density and a high proportion of hollow space. Such a load Lis a bulk material, such as hay or straw. Insofar as the load L protrudes above the substructure 2, the structure 1 is lifted, for example by means of the stanchions 6, 7, 8 and 9 via the relevant stanchion drive 11. The roof 3 is then closed and lowered onto the load L so that the load L is compressed into the loading space 2a. This process can be repeated multiple times until the load L has a reduced proportion of hollow space and is compressed as tightly as possible. This ensures that the loading space 2a is filled as completely as possible, so that transportation is economical and efficient. Finally, the structure 1 and the roof 3 are locked to the substructure 2. Furthermore, the driver is informed of the readiness to drive via a locking sensor 29 of the substructure 2.

The present disclosure has been described above with reference to embodiments in which the body is raised before the roof is closed, so that the roof can be closed despite the load projecting upwards. It is understood that if the load does not protrude upwards, it is not necessary to lift the body in order to close the roof, so that after loading from above, the substructure, for example a semi-trailer, is immediately ready for departure when the roof is closed.

What is claimed is:

1 to 54. (canceled)

55. A structure for a substructure, such as a truck, trailer, semi-trailer, railway wagon, dump truck, or container, comprising:
a body; and
an openable roof,
wherein the roof is displaceable at its edges along two longitudinal beams of the body,
wherein in a closed state the roof closes a roof opening between the two longitudinal beams,
wherein in an opened state the roof mostly exposes the roof opening between the two longitudinal beams,
wherein each longitudinal beam is supported in a height-adjustable manner relative to the substructure via at least one lifting assembly,
wherein the body is adjustable at least in height relative to the substructure depending on a height adjustment of the lifting assembly,
wherein at least one lifting drive is provided which displaces the body together with the roof in height relative to the substructure,
wherein the lifting drive applies a force in the substructure for compressing a load protruding beyond the substructure by lowering the body with the closed roof onto the substructure against a tension of the protruding load, and
wherein the openable roof absorbs generated forces that arise when the load is compressed.

56. The structure according to claim 55,
wherein each longitudinal beam is supported in a height-adjustable manner relative to the substructure via at least two stanchions,
wherein the stanchions each comprise a stanchion lower part assigned to the substructure and a stanchion upper part which is displaceable relative to the stanchion lower part and is assigned to the longitudinal beam, and
wherein the lifting drive is configured as a stanchion drive which displaces at least one of the stanchion upper parts in height relative to the corresponding stanchion lower part.

57. The structure according to claim 56,
wherein a stanchion is arranged in each corner region of the substructure,
wherein each of the four stanchions comprises its own stanchion drive, and
wherein each of the stanchion drives can be actuated independently of the other stanchion drives.

58. The structure according to claim 56, wherein a plurality of the at least two stanchions can be moved simultaneously in height.

59. The structure according to claim 55, wherein the lifting drive is selected from the group comprising pneumatic drives, hydraulic drives, electric drives, spindle drives, rack and pinion drives, cable pull drives, driven scissor kinematics, driven multi-joint kinematics and combinations of thereof.

60. The structure according to claim 55, wherein the longitudinal beam is connected to the lifting drive via coupling kinematics which allow tolerance compensation.

61. The structure according to claim 60, wherein the coupling kinematics is selected from the group comprising ball joints, joint connectors, slot-pin combinations, bolt-eye combinations, hinges and combinations thereof.

62. The structure according to claim 55, wherein the openable roof comprises multiple roof elements coupled to one another which can be folded together accordion-like to open the roof and when the roof is closed close the roof opening lying next to one another.

63. The structure according to claim 55,
wherein each longitudinal beam comprises a longitudinal beam base part which is assigned to the lifting drive and a longitudinal beam guide part which is assigned to the roof, and
wherein the longitudinal beam guide part is displaceable at least in a direction transverse to an extension of the longitudinal beam with respect to the longitudinal beam base part.

64. The structure according to claim 55, further comprising a distance sensor, wherein the distance sensor emits a signal when the distance sensor detects that the roof is completely lowered.

65. The structure according to claim 56, wherein a locking assembly is provided which locks one of said lifting drive and said upper and lower parts displaced relatively by the lifting drive when one of said roof and said body is completely lowered or at least partially raised.

66. The structure according to claim 55,
wherein the two longitudinal beams are connected to one another in the region of at least one of their ends by a cross member,
wherein said cross member is variable in length.

67. The structure according to claim 55,
wherein the roof is configured to be foldable for opening,
wherein the folded roof can be pushed together in an end region of the longitudinal beams, thereby at least partially uncovering the roof opening, and
wherein the folded roof projects downwards relative to the longitudinal beams.

68. The structure according to claim 55,
wherein the body can be lifted by the lifting drive, and
wherein the body, under the load of one of its mass and a spring device, compresses the load during a lowering movement of the body in a direction of the substructure.

69. The structure according to claim 55,
wherein the body can be lowered by the lifting drive, and
wherein the body compresses the load during a lowering movement of the body in a direction of the substructure under an action of the lifting drive.

70. The structure according to claim 55,
wherein the body comprises an attachment for a manual clamping device, such as an eccentric lever device, and
wherein the body can be displaced in a direction of the substructure by actuating the manual clamping device.

71. The structure according to claim 55,
wherein the roof is configured to be foldable for opening,
wherein the folded roof can be pushed together in an end region of the longitudinal
beams, thereby at least partially clearing the roof opening, and
wherein the folded roof projects upwards relative to the longitudinal beams.

72. A structure for a substructure, such as a truck, trailer, semi-trailer, railway wagon, dump truck, or container, comprising:
a body; and
an openable roof,
wherein the roof comprises longitudinal edges,
wherein said roof is displaceable at its longitudinal edges along two longitudinal beams of the body,
wherein, in a closed state, the roof closes a roof opening between the two longitudinal beams,
wherein, in an opened state, the roof substantially uncovers the roof opening between the two longitudinal beams,
wherein the roof is configured to be foldable for opening,
wherein the folded roof can be pushed together in an end region of the longitudinal beams, thereby substantially uncovering the roof opening,
wherein the folded roof projects upwards relative to the longitudinal beams,
wherein each longitudinal beam is supported in a height-adjustable manner relative to the substructure via at least one lifting assembly,
wherein the body is adjustable at least in height relative to the substructure depending on a height adjustment of the lifting assembly,
wherein at least one lifting drive is provided which displaces the body together with the roof in height relative to the substructure,
wherein the lifting drive applies a force in the substructure for compressing a load protruding beyond the substructure by lowering the body with the closed roof onto the substructure against a pre-tension of the protruding load, and
wherein the openable roof absorbs arising forces of the compressed load.

73. A structure for a substructure, wherein the substructure is selected from the group comprising a truck, a trailer, a semi-trailer, a railway wagon, a dump truck, and a container, comprising:
a body; and
an openable roof;
wherein the roof is displaceable at its edges along two longitudinal beams of the body,
wherein the roof is assigned a roof drive which enables the roof to be opened and closed,
wherein the openable roof comprises a roof material selected from the group comprising a tarpaulin made of weather-resistant material, a net panel, and a web-like material,
wherein said roof material is connected to each of the two longitudinal beams via multiple bows, each having end-side sliding carriages,
wherein each longitudinal beam is supported in a height-adjustable manner relative to the substructure via at least one lifting assembly,
wherein the body is adjustable at least in height relative to the substructure depending on a height adjustment of the lifting assembly,
wherein at least one lifting drive is provided which displaces the body together with the roof in height relative to the substructure,
wherein the lifting drive is configured to apply a force into the substructure for compressing a load protruding beyond the substructure by lowering the body with the closed roof onto the substructure against a pre-tension of the protruding load,
wherein the openable roof is configured to absorb a force that arises when the load is compressed, and
wherein the lifting drive comprises an overload protection arrangement which prevents the body from being closed with a closing force exceeding a threshold value for the loading of the roof.

74. The structure according to claim 73, wherein the overload protection arrangement is selected from the group comprising a slip clutch, a pressure sensor, a torque limiter, a current limiter, a temperature switch, a pressure relief valve, a safety clutch and combinations thereof.
